(19) United States
(12) Patent Application Publication
(10) Pub. No.: US 2026/0340345 A1
(43) Pub. Date: Oct. 29, 2026

(54) STAGED MIXED PARALLELISM REASONING METHOD AND SYSTEM FOR MOE SPARSE LARGE MODELS

(71) Applicant: BEIJING UNIVERSITY OF POSTS AND TELECOMMUNICATIONS, Beijing (CN)

(72) Inventors: Shigang LI, Beijing (CN); Jiahao CHEN, Beijing (CN); Jingkun DONG, Beijing (CN); Zhi MA, Beijing (CN); Xiaofei WU, Beijing (CN)

(73) Assignee: BEIJING UNIVERSITY OF POSTS AND TELECOMMUNICATIONS, Beijing (CN)

(21) Appl. No.: 19/391,161

(22) Filed: Nov. 17, 2025

Related U.S. Application Data
(63) Continuation of application No. PCT/CN2025/120774, filed on Sep. 11, 2025.

(30) Foreign Application Priority Data
Apr. 28, 2025 (CN) 202510542935.0

(51) Int. Cl. G06N 3/045; G06N 3/0495

(52) U.S. Cl. CPC G06N 3/045; G06N 3/0495

(57) ABSTRACT

The present disclosure provides a staged mixed parallelism reasoning method and system for an MoE sparse large model. The method includes: controlling the MoE sparse large model to execute the following steps layer by layer in a prefill stage: adding first MoE layer model parameters running based on a tensor parallelism strategy to each device while acquiring an expert number of each token of a prompt data sequence; then performing expert parallelism computation based on second MoE layer model parameters in each device running based on an expert parallelism strategy; restoring the tokens to device initial positions and releasing the second MoE layer model parameters; and sending a predicted token output by a last layer of the model to a first layer to execute reasoning in a decoding stage according to the predicted token and the first MoE layer model parameters in each device. The present disclosure can solve the problems that a parallelism strategy adopted by an existing MoE sparse large model reasoning technology has poor adaptability to the prefill stage and the decoding stage and large communication overhead.

### RELATED APPLICATIONS

This application is a continuation of International Application No. PCT/CN2025/120774, filed on Sep. 11, 2025, which claims priority to Chinese Patent Application No. CN202510542935.0, entitled “Staged Mixed Parallelism Reasoning Method and System for MoE Sparse Large Models”, filed with China National Intellectual Property Administration on Apr. 28, 2025, both of which are hereby incorporated by reference in their entireties.

### TECHNICAL FIELD

The present disclosure relates to the technical field of computing systems based on specific computing models, and in particular, to a staged mixed parallelism reasoning method and system for MoE sparse large models.

### BACKGROUND

An MoE (mixture-of-expert) sparse large model means that a sparse activation mechanism is introduced on the basis of an MoE model, and compared with the MoE model with a computing amount close to that of a dense model, the MoE sparse large model replaces the MLP (Multilayer Perceptron) layer in the MoE model with a gating function and a plurality of experts, and the multi-head attention layer is the same as that in the MoE model. In the MoE sparse large model, each token can only activate some experts for computation, so that computing overhead is increased sublinearly with a model capacity, and the effect of rapid model parameter expansion is achieved. Compared with a traditional dense large model, the MoE sparse large model can obviously reduce the computing cost with the same number of parameters. A reasoning computing process of a large model can be divided into two processes: a prefill stage and a decoding stage.

Currently, a parallelism strategy adopted by a distributed reasoning mode of the existing MoE sparse large model has poor adaptability to the prefill stage and the decoding stage. For example, a mixed parallelism strategy of “data parallelism+tensor parallelism+expert parallelism” is proposed in DeepSpeed-MoE, and the expert parallelism is limited within a node, so that a communication efficiency of AlltoAll communication is improved by utilizing a high bandwidth in the node. Since the parallelism strategies of the prefill stage and the decoding stage are not differentiated in DeepSpeed-MoE, the prefill stage has a large processed data amount, and the decoding stage has low computing density and a small processed data amount, a large number of data AllGather and ReduceScatter communication operations can be brought when the tensor parallelism strategy is adopted in the prefill stage, and then, communication overhead is increased, which is more serious when a large amount of data is processed; and meanwhile, AlltoAll communication overhead generated when the expert parallelism strategy is adopted in the decoding stage is also more remarkable.

Therefore, currently, an MoE sparse large model reasoning mode is continuously designed to solve the problems that the parallelism strategy adopted by an existing MoE sparse large model reasoning technology has poor adaptability to the prefill stage and the decoding stage and large communication overhead.

### SUMMARY

In view of this, embodiments of the present disclosure provide a staged mixed parallelism reasoning method and system for an MoE sparse large model, so as to obviate or mitigate one or more defects in the prior art.

In an aspect, the present disclosure provides a staged mixed parallelism reasoning method for an MoE sparse large model, including:
in a prefill stage of data reasoning based on the MoE sparse large model, controlling architecture layers of the MoE sparse large model to execute a first step layer by layer; wherein the first step includes: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device; and then restoring the tokens subjected to the expert parallelism computation to the respective device initial positions and releasing the second MoE layer model parameters in each device; wherein the first MoE layer model parameters run based on a tensor parallelism strategy, and the second MoE layer model parameters run based on an expert parallelism strategy; and
sending a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.

In some embodiments of the present disclosure, the staged mixed parallelism reasoning method for an MoE sparse large model further includes:
in each iteration in the decoding stage of data reasoning based on the MoE sparse large model, controlling the architecture layers of the MoE sparse large model to execute a second step layer by layer, and sending a predicted token output by the last architecture layer of the MoE sparse large model in each iteration to the multi-head attention layer in the first architecture layer of the MoE sparse large model in an AlltoAll communication mode;
wherein the second step includes:
in the current iteration, acquiring respective expert numbers of tokens which correspond to a latest data sequence and are currently respectively located at the respective device initial positions based on the multi-head attention layer model parameters and the gating function in each device ; wherein if the current iteration is the first iteration, the latest data sequence includes the prompt data sequence cached in the prefill stage and the predicted token output by the last architecture layer of the MoE sparse large model in the prefill stage; if the current iteration is not the first iteration, the latest data sequence includes the prompt data sequence, the predicted token output in the prefill stage and the predicted tokens output in the historical iterations before the current iteration respectively;
collecting the tokens into respective devices in an AllGather communication mode, and causing the respective devices to perform tensor parallelism computation on the gathered tokens according to the respective corresponding first MoE layer model parameters running based on the tensor parallelism strategy according to the respective expert numbers of the tokens; and
restoring the tokens subjected to the tensor parallelism computation to the respective device initial positions in a ReduceScatter communication mode.

In some embodiments of the present disclosure, the acquiring respective expert numbers of tokens which correspond to a prompt data sequence and are currently respectively located at respective device initial positions based on multi-head attention layer model parameters and a gating function in each device includes:
dividing the prompt data sequence into a plurality of first data subsequences according to a total number of the devices; and
inputting each of the first data subsequences into each device on an one to one basis, so as to cause each device to perform multi-head attention computation on the respective received first data subsequences based on the respective stored multi-head attention layer model parameters respectively to obtain tokens corresponding to the respective received first data subsequences, and respectively determining the respective expert numbers of the tokens on each device based on the gating function;
correspondingly, the acquiring respective expert numbers of tokens which correspond to a latest data sequence and are currently respectively located at the respective device initial positions based on the multi-head attention layer model parameters and the gating function in each device includes:
equally dividing the latest data sequence into a plurality of second data subsequences according to the total number of the devices; and
inputting each of the second data subsequences into each device on an one to one basis, so as to cause each device to perform multi-head attention computation on the respective received second data subsequences based on the respective stored multi-head attention layer model parameters respectively to obtain tokens corresponding to the respective received second data subsequences, and gathering all the tokens onto each device in an AllGather communication mode, so as to cause each device to determine the respective expert numbers of the tokens on each device based on the gating function.

In some embodiments of the present disclosure, the meanwhile adding first MoE layer model parameters to each device includes:
if the time required for adding the first MoE layer model parameters to each device is shorter than or equal to the time required for acquiring the respective expert numbers of the tokens which correspond to the prompt data sequence and are currently respectively located at the respective device initial positions, adding the first MoE layer model parameters to each device while acquiring the respective expert numbers of the tokens which correspond to the prompt data sequence and are currently respectively located at the respective device initial positions.

In some embodiments of the present disclosure, before restoring the tokens subjected to the expert parallelism computation to the respective device initial positions in the first step, the method further includes:
if the time required for adding the first MoE layer model parameters to each device is longer than the time required for acquiring the respective expert numbers of the tokens which correspond to the prompt data sequence and are currently respectively located at the respective device initial positions, dividing the respective corresponding first MoE layer model parameters of each device into a first part of parameters and a second part of parameters;
acquiring the respective expert numbers of the tokens which correspond to the prompt data sequence and are currently respectively located at the respective device initial positions based on the multi-head attention layer model parameters and the gating function in each device, and meanwhile adding the first part of parameters to the devices; and
then performing the expert parallelism computation on the tokens according to the respective expert numbers of the tokens and the respective corresponding second MoE layer model parameters in each device, and meanwhile adding the second part of parameters to each device.

In some embodiments of the present disclosure, the performing the expert parallelism computation on the tokens according to the respective expert numbers of the tokens and the respective corresponding second MoE layer model parameters in each device includes:
according to the respective expert numbers of the tokens, with the goal of equaling numbers of the tokens processed by each device during the expert parallelism computation and preferentially arranging the tokens with the smallest expert numbers in a global range in each device locally, performing load balancing processing based on a greedy algorithm on the tokens in the devices; and
respectively routing the tokens subjected to the load balancing processing to the devices where the respective expert numbers are located currently in an AlltoAll communication mode, so as to cause each device to respectively perform the expert parallelism computation on the respective received tokens according to the respective corresponding second MoE layer model parameters.

In some embodiments of the present disclosure, the according to the respective expert numbers of the tokens, with the goal of equaling numbers of the tokens processed by each device and preferentially arranging the tokens with the smallest expert numbers in a global range in each device locally, performing load balancing processing based on a greedy algorithm on the tokens in the devices includes:
controlling each device to sort the local tokens in an ascending order of their expert numbers to determine distribution of the respective local tokens of each device among experts, and respectively acquiring distribution of the local tokens of other devices among experts in an AllGather communication mode, so as to determine global distribution of the tokens among experts;
controlling each device to respectively determine token distribution after the devices route the tokens to the devices where the respective expert numbers are located currently according to the global distribution of the tokens among experts;
controlling each device to respectively determine initial addresses and offsets of the tokens sent by the devices and initial addresses and offsets of the tokens received by the devices according to the distribution of the respective local tokens in the experts and the token distribution after the devices route the tokens to the devices where the respective expert numbers are located currently; and
inputting the initial addresses and the offsets of the tokens sent by the devices, the initial addresses and the offsets of the tokens received by the devices, a buffer of sent data region and a buffer region of received data as input parameters into an AlltoAll communication function corresponding to the AlltoAll communication mode.

In some embodiments of the present disclosure, after determining initial addresses and offsets of the tokens sent by the devices and initial addresses and offsets of the tokens received by the devices, the method further includes:
if it is determined that a device where an expert is missed exists after the AlltoAll communication according to the offsets of the tokens sent by the devices and the offsets received by the devices, loading the second MoE layer model parameters corresponding to the missed expert from a memory of a processor to the device before the device performs the expert parallelism computation on the tokens based on the second MoE layer model parameters corresponding to the missed expert.

In another aspect, the present disclosure provides a staged mixed parallelism reasoning apparatus for an MoE sparse large model, including:
a prefill stage executing module configured to, in a prefill stage of data reasoning based on the MoE sparse large model, control architecture layers of the MoE sparse large model to execute a first step layer by layer; wherein the first step includes: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device; and then restoring the tokens subjected to the expert parallelism computation to the respective device initial positions and releasing the second MoE layer model parameters in each device; wherein the first MoE layer model parameters run based on a tensor parallelism strategy, and the second MoE layer model parameters run based on an expert parallelism strategy; and
a stage change executing module configured to send a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.

In some embodiments of the present disclosure, the staged mixed parallelism reasoning apparatus for an MoE sparse large model further includes:
a decoding stage executing module configured to, in each iteration in the decoding stage of data reasoning based on the MoE sparse large model, control the architecture layers of the MoE sparse large model to execute a second step layer by layer, and send a predicted token output by the last architecture layer of the MoE sparse large model in each iteration to the multi-head attention layer in the first architecture layer of the MoE sparse large model in an AlltoAll communication mode;
wherein the second step includes:
in the current iteration, acquiring respective expert numbers of tokens which correspond to a latest data sequence and are currently respectively located at the respective device initial positions based on the multi-head attention layer model parameters and the gating function in each device; wherein if the current iteration is the first iteration, the latest data sequence includes the prompt data sequence cached in the prefill stage and the predicted token output by the last architecture layer of the MoE sparse large model in the prefill stage; if the current iteration is not the first iteration, the latest data sequence includes the prompt data sequence, the predicted token output in the prefill stage and the predicted tokens output in the historical iterations before the current iteration respectively;
according to the respective expert numbers of the tokens, respectively routing the tokens into the devices where the respective expert numbers are located currently in an AlltoAll communication mode, so as to cause the devices to perform tensor parallelism computation on the respective received tokens according to the respective corresponding first MoE layer model parameters running based on the tensor parallelism strategy; and
restoring the tokens subjected to the tensor parallelism computation to the respective device initial positions in a ReduceScatter communication mode.

In a third aspect, the present disclosure provides a staged mixed parallelism reasoning system for an MoE sparse large model, including: a scheduling apparatus and devices in communication connection with the scheduling apparatus; wherein the scheduling apparatus includes a memory, a processor and a computer program stored in the memory and operable on the processor, and when the processor executes the computer program, the staged mixed parallelism reasoning method for an MoE sparse large model of the first aspect is implemented.

In a fourth aspect, the present disclosure provides an electronic device, including: a memory, a processor and a computer program stored in the memory and operable on the processor, wherein when the processor executes the computer program, the staged mixed parallelism reasoning method for an MoE sparse large model is implemented.

In a fifth aspect, the present disclosure provides a computer-readable storage medium having a computer program stored thereon, the computer program, when executed by a processor, implementing the staged mixed parallelism reasoning method for an MoE sparse large model.

In a sixth aspect, the present disclosure provides a computer program product, including a computer program, the computer program, when executed by a processor, implementing the staged mixed parallelism reasoning method for an MoE sparse large model.

In the staged mixed parallelism reasoning method for an MoE sparse large model according to the present disclosure, for the prefill stage with a high processed data amount, an MoE layer adopts the expert parallelism strategy with a relatively lower communication amount to effectively reduce overhead of communication among the devices in the prefill stage. For the decoding stage with a low processed data amount, the MoE layer adopts the more efficient tensor parallelism strategy to effectively reduce the overhead of communication among the devices in the decoding stage, adaptability to the prefill stage and the decoding stage can be effectively improved, and an efficiency of the reasoning process of the MoE sparse large model can be improved. By adding the first MoE layer model parameters running based on the tensor parallelism strategy to the devices while multi-head attention layer computation is performed in the prefill stage, communication overhead of a parallelism strategy change can be hidden in a layer-by-layer change mode without obviously increasing a device resource occupancy rate; after computation of the MoE layer of each architecture layer in the prefill stage is finished, the second MoE layer model parameters running based on the expert parallelism strategy can be released layer by layer, which can further avoid an increase of the device resource occupancy rate.

Additional advantages, objects and features of the present disclosure will be set forth in part in the description which follows and in part will become apparent to those having ordinary skill in the art upon examination of the following or may be learned from practice of the present disclosure. The objects and other advantages of the present disclosure will be achieved and attained by the structure particularly pointed out in the specification and drawings.

It will be appreciated by those skilled in the art that the objects and advantages that can be achieved with the present disclosure are not limited to what has been particularly described hereinabove, and that the above and other objects that can be achieved with the present disclosure will be more clearly understood from the following detailed description.

### BRIEF DESCRIPTION OF THE DRAWINGS

The accompanying drawings described herein are used to provide a further understanding of the present disclosure, constitute a part of the present disclosure, and do not limit the present disclosure. In the drawings:

FIG. 1 is a schematic diagram of architectural layers of an MoE sparse large model.

FIG. 2 is a schematic diagram of token routing (1) from data parallelism of a multi-head attention layer to expert parallelism of an MoE layer with 4 devices and 8 experts as an example in the prior art.

FIG. 3 is a schematic diagram of token routing (2) from the expert parallelism of the MoE layer to the data parallelism of the multi-head attention layer with 4 devices and 8 experts as an example in the prior art.

FIG. 4 is a first schematic flow diagram of a staged mixed parallelism reasoning method for an MoE sparse large model according to an embodiment of the present disclosure.

FIG. 5 is an exemplary view of an MoE sparse large model with two basic architecture layers in series and 8 experts per basic architecture layer as an example.

FIG. 6 is a first schematic flow diagram of a first step in the staged mixed parallelism reasoning method for an MoE sparse large model according to an embodiment of the present disclosure.

FIG. 7 is a second schematic flow diagram of the staged mixed parallelism reasoning method for an MoE sparse large model according to an embodiment of the present disclosure.

FIG. 8 is a first schematic flow diagram of a second step in the staged mixed parallelism reasoning method for an MoE sparse large model according to an embodiment of the present disclosure.

FIG. 9 is a second schematic flow diagram of the first step in the staged mixed parallelism reasoning method for an MoE sparse large model according to an embodiment of the present disclosure.

FIG. 10 is a second schematic flow diagram of the second step in the staged mixed parallelism reasoning method for an MoE sparse large model according to an embodiment of the present disclosure.

FIG. 11 is a third schematic flow diagram of the first step in the staged mixed parallelism reasoning method for an MoE sparse large model according to an embodiment of the present disclosure.

FIG. 12 is a fourth schematic flow diagram of the first step in the staged mixed parallelism reasoning method for an MoE sparse large model according to an embodiment of the present disclosure.

FIG. 13 is a schematic diagram of token routing (1) from the data parallelism of the multi-head attention layer to the expert parallelism of the MoE layer with 4 devices and 8experts as an example in an embodiment of the present disclosure.

FIG. 14 is a schematic diagram of a staged mixed parallelism strategy of an MoE layer in an application example of the present disclosure.

FIG. 15 is a schematic diagram of a parallelism strategy in the prefill stage with 4 devices as an example in the application example of the present disclosure.

FIG. 16 is a schematic diagram of a parallelism strategy in decoding stage with 4 devices as an example in the application example of the present disclosure.

FIG. 17 is a schematic diagram of token routing (2) from expert parallelism of the MoE layer to data parallelism of a multi-head attention layer with 4 devices and 8 experts as an example in the application example of the present disclosure.

FIG. 18 is a schematic diagram of a data transmission overhead hiding technology in the application example of the present disclosure.

FIG. 19A is a schematic diagram of comparison of performance test results of a prefill stage between the present disclosure and DeepSeek-MoE when batchsize=128 and sequence_length=2,048 in the application example of the present disclosure.

FIG. 19B is a schematic diagram of comparison of the performance test results of the prefill stage between the present disclosure and DeepSeek-MoE when batchsize=256 and sequence_length=2,048 in the application example of the present disclosure.

FIG. 20A is a schematic diagram of comparison of performance test results of a decoding stage between the present disclosure and DeepSeek-MoE when batchsize=128 and 100 tokens are output after reasoning in the application example of the present disclosure.

FIG. 20B is a schematic diagram of comparison of the performance test results of the decoding stage between the present disclosure and DeepSeek-MoE when batchsize=256 and 100 tokens are output after reasoning in the application example of the present disclosure.

FIG. 21A is a schematic diagram of comparison of performance test results of end-to-end reasoning (prefill+decoding) between the present disclosure and DeepSeek-MoE when batchsize=128, sequence_length=2,048 and 100 tokens are output after reasoning in the application example of the present disclosure.

FIG. 21B is a schematic diagram of comparison of the performance test results of end-to-end reasoning (prefill+decoding) between the present disclosure and DeepSeek-MoE when batchsize=256, sequence_length=2,048 and 100 tokens are output after reasoning in the application example of the present disclosure.

### DETAILED DESCRIPTION

In order to make the objects, technical solutions and advantages of the present disclosure more apparent, the present disclosure is described in further detail below with reference to the embodiments and the accompanying drawings. Herein, the exemplary embodiments of the present disclosure and the descriptions thereof are used to explain the present disclosure, but not to limit the present disclosure.

It should also be noted herein that, in order to avoid obscuring the present disclosure with unnecessary details, only the structures and/or processing steps closely related to the solution according to the present disclosure are shown in the drawings, and other details not so related to the present disclosure are omitted.

It should be emphasized that the term “includes/comprises” when used herein, is taken to specify the presence of features, elements, steps or components, but does not preclude the presence or addition of one or more other features, elements, steps or components.

Here, it is also noted that, unless otherwise specified, the term “connected” is used herein to refer not only to direct connection, but also to indirect connection with an intermediate.

Hereinafter, embodiments of the present disclosure will be described with reference to the drawings. In the drawings, the same reference numerals denote the same or similar components or the same or similar steps.

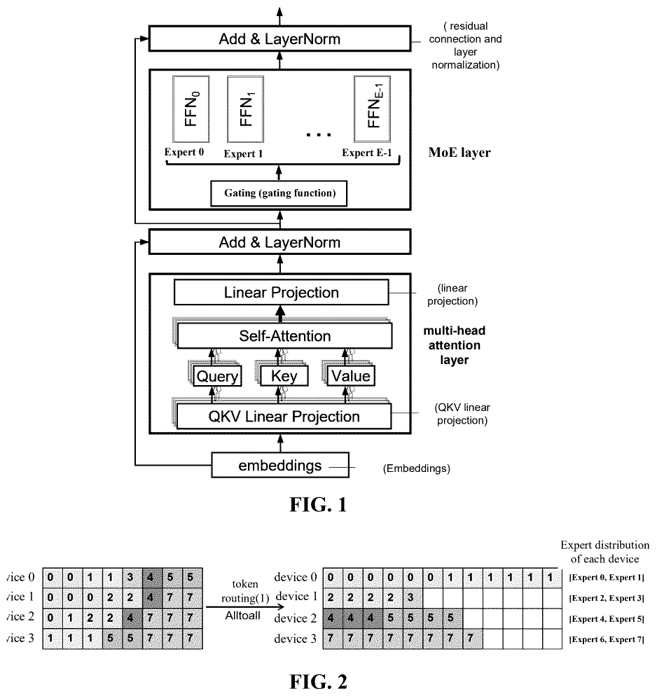

In recent years, the scale of parameters of large models is increased rapidly. Training of the large models requires a large number of computing resources. For example, taking GPT-4 with 1.8 trillion parameters as an example, computing power required for training GPT-4 is equivalent to running on 25 thousand NVIDIA A100 GPUs for 90 to 100 days. An MoE sparse large model can effectively reduce training overhead of the large model and realize a sublinear increase of computing overhead with a capacity of the model. The MoE sparse large model is composed of a plurality of architecture layers (also called MoE large model basic architecture layers) which are connected in series in sequence, and as shown in FIG. 1, one architecture layer includes a multi-head attention layer and an MoE layer which are connected, and multiple such architecture layers can be connected in series to form a multilayer deep neural network. FFN0, FFN1 and FFNE-1 respectively represent MoE layer model parameters corresponding to different experts, “Query” represents a “problem” feature or a “target” feature needing to be concerned and can be abbreviated as Q; “Key” represents a reference feature providing a “position” or “matching basis”, and can be abbreviated as K; “Value” represents carried actual information for weighted aggregation, and can be abbreviated as V; QKV Linear Projection is a core operation in an attention mechanism for generating Query (Q), Key (K), and Value (V), and input data is mapped to different semantic spaces by linear transformation. In the MoE sparse large model, after each token passes through a gating function, an affinity score of the token with each expert is calculated, the top-K experts with the highest affinity scores are then selected for computation, K≥1, and each token does not need to be subjected to computation of all the experts, thereby a computing cost can be remarkably reduced. Current mainstream large models, such as DeepSeek and Mixtral, adopt an MoE architecture to reduce costs.

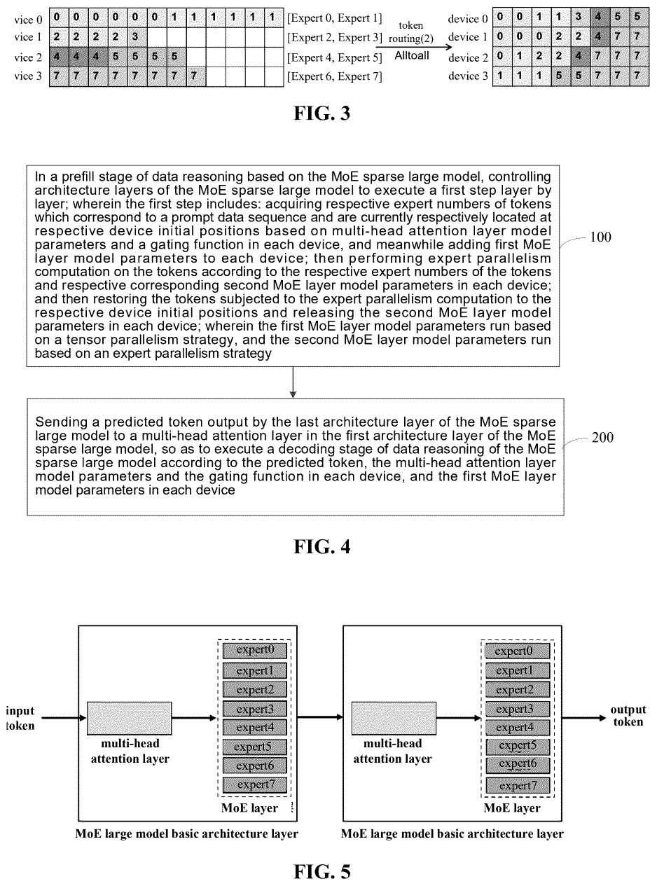

MoE sparse large models introduce an expert parallelism model. For the MoE layer in MoE sparse large models, expert parallelism realizes segmentation of expert parameters by uniformly dividing all the experts into different devices; for the multi-head attention layer, a data parallelism mode may be adopted, that is, complete multi-head attention layer model parameters can be stored on each device. The input tokens are divided to the devices for multi-head attention layer computation, and then, the tokens are routed to the devices where the corresponding experts are located for MoE layer computation through an AlltoAll communication operation according to the affinity score computation result of the gating function, as shown in FIG. 2. In FIG. 2, 8 experts are equally divided onto 4 devices, each grid in FIG. 2 represents one token, the number in the grid represents a routing expert number (also referred to as a target expert number or expert ID, etc.), and each expert number corresponds to each expert. After the MoE layer computation is finished, the tokens are routed back to the initial devices through an AlltoAll communication operation, as shown in FIG. 3, that is, the tokens after the expert parallelism computation are respectively restored to device initial positions in the multi-head attention layer computation, so as to proceed to data parallelism computation of the multi-head attention layer of the next layer.

The MoE models can significantly reduce the large model computing cost. However, the MoE sparse large models still face challenges in a reasoning performance. A reasoning computing process of the large model can be divided into two processes: a prefill stage and a decoding stage. The prefill stage is a computing process for inputting a prompt word (such as a user question) to the model to generate a first token. The decoding stage is a computing process for iteratively generating a next token according to a current input sequence and a newly generated token after the first token is generated. Decoding is an iterative computing process, and one new token is generated in each iteration until a maximum generation length is reached or a termination token is encountered. In a PD-integrated (such as DeepSpeed-MoE) reasoning solution, the prefill stage and the decoding stage share the same computing device. However, the prefill stage is computation intensive, the decoding stage is memory intensive, and the two stages in the PD-integrated reasoning solution interfere with each other. Therefore, a PD-separated technology is proposed in certain research, and different computing devices are used in the prefill stage and the decoding stage respectively to realize physical resource separation, which eliminates the interference between the two stages, and enables each stage to focus on an optimization objective thereof. That is, the prefill stage focuses on optimizing a first token delay index, and the decoding stage focuses on optimizing an output token delay index. However, different computing devices are used in the prefill stage and the decoding stage in the PD-separated technology, and therefore, the PD-separated technology requires more computing resources. In addition, in the PD-separated technology, after the computation in the prefill stage is finished, KV-cache calculated in the prefill stage needs to be transmitted to a decoding device, and then, the decoding device can perform subsequent computation, which brings additional data transmission overhead. Therefore, the PD-separated solution and the PD-integrated solution have their own advantages and disadvantages.

In the expert parallelism of distributed reasoning of MoE sparse large models, the problem of load unbalance caused by dynamic routing of tokens is one of key factors influencing the reasoning performance. As shown in FIG. 2, in token routing from data parallelism of the multi-head attention layer to expert parallelism of the MoE layer, the dynamic routing of the tokens may cause different numbers of tokens processed on the devices, and meanwhile, AlltoAll communication loads are also unbalanced, that is, numbers of tokens received on the devices are different. As shown in FIG. 3, in token routing from the expert parallelism of the MoE layer to the data parallelism of the multi-head attention layer, the dynamic routing of the tokens can cause unbalanced AlltoAll communication loads, that is, numbers of tokens sent on the devices are different. Therefore, in reasoning of MoE sparse large models, the dynamic routing of the tokens can cause the unbalance of the computing loads and the communication loads. In order to alleviate the load unbalance problem, Gshard (an efficient data processing technology designed based on a distributed computing concept) proposes an expert capacity upper limit design, that is, tokens exceeding an expert capacity directly skip the MoE layer by using a residual network, and tokens not reaching a capacity upper limit are supplemented by filling. Although this strategy can balance the computing and communication loads, the disadvantages is that it may generate useless computation and meanwhile may cause precision loss due to token discarding during reasoning, which is quite difficult to accept during reasoning. In DeepSeek V3, a load balancing strategy without auxiliary loss is used, the strategy introduces an adjustable bias value for each expert, and the bias value is added to the expert affinity score calculated by the gating function to adjust the load on each expert. The bias value will be decreased for experts with high loads and be increased for experts with low loads, so that the loads of the experts are balanced as much as possible. However, this strategy cannot completely solve the load unbalance problem.

That is, for distributed reasoning of MoE sparse large models, the parallelism strategy adopted in the prior art, especially the PD-integrated reasoning solution, has poor adaptability to the prefill stage and the decoding stage. DeepSpeed-MoE is an optimization technique for an MoE network, and is intended to improve efficiencies of training and reasoning of a large-scale language model (LLM), and DeepSpeed-MoE provides a mixed parallelism strategy of “data parallelism+tensor parallelism+expert parallelism”, and limits the expert parallelism in a node, so as to improve an AlltoAll communication efficiency by utilizing a high bandwidth in the node. However, the parallelism strategy adopted by DeepSpeed-MoE does not distinguish the prefill stage from the decoding stage, and the parallelism strategy of the whole reasoning process is not changed, and is not adapted to the computing load characteristics of the two stages.

Based on this, in order to solve the problems that the parallelism strategy adopted by the existing MoE sparse large model reasoning technology has poor adaptability to the prefill stage and the decoding stage and has high communication overhead, embodiments of the present disclosure respectively provide a staged mixed parallelism reasoning method for MoE sparse large models, a staged mixed parallelism reasoning apparatus for MoE sparse large models for executing the staged mixed parallelism reasoning method for MoE sparse large models, a staged mixed parallelism reasoning system for MoE sparse large models, an electronic device, a computer-readable storage medium and a computer program product. By adopting a staged mixed parallelism reasoning mode, different adaptive parallelism strategies are adopted for different stages, and efficient connection is performed by a layer-by-layer parallelism strategy change method, so that a better performance can be achieved compared with the existing MoE sparse large model reasoning technology.

Details are explained by the following embodiments.

Based on this, an embodiment of the present disclosure provides a staged mixed parallelism reasoning method for an MoE sparse large model, which can be implemented by a staged mixed parallelism reasoning apparatus of an MoE sparse large model, and referring to FIG. 4, the staged mixed parallelism reasoning method for an MoE sparse large model specifically includes the following contents:
step 100: in a prefill stage of data reasoning based on the MoE sparse large model, controlling architecture layers of the MoE sparse large model to execute a first step layer by layer;
wherein the first step includes: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device; and then restoring the tokens subjected to the expert parallelism computation to the respective device initial positions and releasing the second MoE layer model parameters in each device, wherein the first MoE layer model parameters run based on a tensor parallelism strategy, and the second MoE layer model parameters run based on an expert parallelism strategy.

In one or more embodiments of the present disclosure, referring to FIG. 5, the architecture layer refers to a basic architecture layer of the MoE sparse large model and can also be called an MoE large model basic architecture layer. The MoE sparse large model is composed of a plurality of architecture layers sequentially connected in series, the first step is executed for the architecture layers layer by layer, the architecture layer is taken as a layer-by-layer execution unit, each architecture layer includes a multi-head attention layer and an MoE layer, an output end of the multi-head attention layer is connected with an input end of the MoE layer, and an output end of the MoE layer is connected with an input end of the multi-head attention layer in the next architecture layer.

It should be noted that, for the prefill stage with a high processed data amount, in the embodiment of the present disclosure, the MoE layer adopts the expert parallelism strategy with a relatively lower communication amount to effectively reduce overhead of communication among the devices in the prefill stage. For a decoding stage with a low processed data amount, in the embodiment of the present disclosure, the MoE layer adopts the more efficient tensor parallelism strategy to effectively reduce the overhead of communication among the devices in the decoding stage, adaptability to the prefill stage and the decoding stage can be effectively improved, and an efficiency of the reasoning process of the MoE sparse large model can be improved. However, since the MoE layer adopts different parallelism strategies in the prefill stage and the decoding stage, the parallelism strategy of the MoE layer needs to be changed from the expert parallelism strategy to the tensor parallelism strategy before the decoding stage is executed. The change of the expert parallelism strategy to the tensor parallelism strategy causes additional communication overhead existing between the devices; if the communication process needs to be avoided, the first MoE layer model parameters running based on the tensor parallelism strategy and the second MoE layer model parameters running based on the expert parallelism strategy, which correspond to each MoE layer in each architecture layer, need to be stored in each device at the same time, which may result in a great increase of a data occupancy rate of each device.

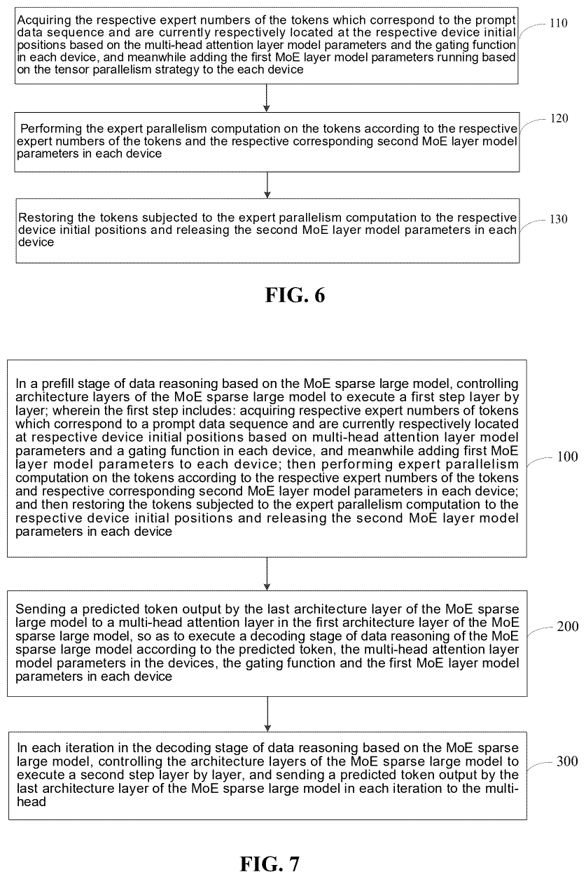

Based on this, in order to avoid that the change of the expert parallelism strategy to the tensor parallelism strategy causes the additional communication overhead existing between the devices and avoid that the data occupancy rate of each device is greatly increased, in the step 100 of the staged mixed parallelism reasoning method for an MoE sparse large model according to the embodiment of the present disclosure, in the prefill stage, the first step is designed separately for each architectural layer in a layer-by-layer manner, and referring to FIG. 6, the first step specifically includes the following contents:
step 110: acquiring the respective expert numbers of the tokens which correspond to the prompt data sequence and are currently respectively located at the respective device initial positions based on the multi-head attention layer model parameters and the gating function in each device, and meanwhile adding the first MoE layer model parameters running based on the tensor parallelism strategy to each device.

It may be understood that the prompt data sequence refers to a text sequence used as prompt information of a predicted token, and a data type of the prompt data sequence can be set according to actual application requirements. In an example, the prompt data sequence may be user question text data. The device initial position refers to a position in the device where each token is located currently.

The multi-head attention layer model parameters refer to model parameters of the multi-head attention layer, and the model parameters of the multi-head attention layer in each architecture layer are stored in each device.

In one or more embodiments of the present disclosure, the tensor parallelism strategy is as follows: high feature dimensions H of all E experts are averagely divided to P devices, the experts owned by each device are [E, H/P], that is, each device has H/P of all the E experts, and each device needs to process all tokens. The first MoE layer model parameters running based on the tensor parallelism strategy refer to the MoE layer model parameters corresponding to [E, H/P] owned by each device; and the first MoE layer model parameters running based on the tensor parallelism strategy are only adopted in the decoding stage, and the current prefill stage is only used for hiding the communication overhead for setting the first MoE layer model parameters running based on the tensor parallelism strategy in the MoE layer.

Step 120: performing the expert parallelism computation on the tokens according to the respective expert numbers of the tokens and the respective corresponding second MoE layer model parameters in each device.

It may be understood that, when the step 110 is executed, the second MoE layer model parameter running based on the expert parallelism strategy and corresponding to at least one expert (or expert number) corresponding to each device already exists in the device, and then, when the step 120 is executed, the second MoE layer model parameter may be directly invoked to perform MoE layer computation on each received token. The expert parallelism strategy is as follows: all the E experts are averagely divided to the P devices, the high feature dimension of each expert is set to H, the experts owned by each device are [E/P, H], and E/P is a number of the experts on each device. The second MoE layer model parameter running based on the expert parallelism strategy refers to the MoE layer model parameter corresponding to [E/P, H] owned by each device.

Step 130: restoring the tokens subjected to the expert parallelism computation to the respective device initial positions and releasing the second MoE layer model parameters in each device.

In the step 130, the step of restoring the tokens subjected to the expert parallelism computation to the respective device initial positions means that after completion of the expert parallelism computation of the MoE layer, the tokens are routed back to the initial devices through an AlltoAll communication operation, so as to proceed to data parallelism computation of the multi-head attention layer of the next layer.

That is, in the first step, during the multi-head attention computation performed by the multi-head attention layer in the current architecture layer, the first MoE layer model parameters, which runs based on the tensor parallelism strategy and corresponds to the multi-head attention layer in the architecture layer, are added to the devices, so that each first MoE layer model parameter added to each device forms the MoE layer running based on the tensor parallelism strategy and uniquely corresponding to the multi-head attention layer in the architecture layer. It should be noted that, in the current state, the multi-head attention layer model parameter corresponding to each architecture layer, the second MoE layer model parameters corresponding to the current architecture layer and subsequent architecture layers, and the first MoE layer model parameters corresponding to the current architecture layer and preceding architecture layers are stored in each device. The subsequent architecture layers refer to all architecture layers behind the current architecture layer, and if the current architecture layer is the last layer of the MoE sparse large model, the subsequent architecture layer is regarded as absent. The preceding architecture layers refer to all architecture layers before the current architecture layer, and if the current architecture layer is the first layer of the MoE sparse large model, the preceding architecture layer is regarded as absent.

In an example, if the MoE sparse large model includes 60 architecture layers sequentially connected in series, and the first step is executed by the 30th architecture layer currently, in the step 110, while each device is controlled to acquire the expert number of each token which corresponds to the prompt data sequence and is currently located at the respective device initial position based on the multi-head attention layer model parameters of the multi-head attention layer of the local 30th layer and the gating function, the first MoE layer model parameters corresponding to the MoE layer of the 30th layer are added to each device. Then, in the step 120, each device is controlled to perform the expert parallelism computation on each token based on the second MoE layer model parameters of the local 30th layer, and in the step 130 after the step 120, the second MoE layer model parameters of the 30th layer of each device are released. At this point, the multi-head attention layer model parameters of the multi-head attention layers of the 60 layers, the second MoE layer model parameters corresponding to the MoE layers of the 31st to 60th layers, and the first MoE layer model parameters corresponding to the MoE layers of the 1st to 30th layers are stored in each device. That is, at this point, for the 60 MoE layers in the 60 architecture layers sequentially connected in series included in the MoE sparse large model, each device only needs to store the first MoE layer model parameters or the second MoE layer model parameters, and each device may store the first MoE layer model parameters and the second MoE layer model parameters corresponding to the same MoE layer only in the process of executing the step 120. Therefore, the overhead of communication between the devices caused by adding the first MoE layer model parameters to each device can be hidden through the multi-head attention computation process of the multi-head attention layer in the current architecture layer, and the data occupancy rate of each device can be effectively prevented from being greatly increased.

Step 200: sending a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.

In the step 200, the predicted token output by the last architecture layer of the MoE sparse large model is obtained in the mode that the MoE layer in the last architecture layer of the MoE sparse large model finally outputs an output sequence corresponding to the prompt data sequence based on the different second MoE layer model parameters in respective devices, and then, the last token is extracted from the output sequence as the predicted token obtained in the prefill stage. The predicted token will form a predicted token string together with the predicted tokens output from each iteration of the decoding stage, to serve as answer text data corresponding to the prompt data sequence such as the user question text data.

From the above description, it can be learnt that, in the staged mixed parallelism reasoning method for an MoE sparse large model according to the embodiment of the present disclosure, for the prefill stage with the high processed data amount, the MoE layer adopts the expert parallelism strategy with the relatively lower communication amount to effectively reduce the overhead of communication among the devices in the prefill stage. For the decoding stage with the low processed data amount, the MoE layer adopts the more efficient tensor parallelism strategy to effectively reduce the overhead of communication among the devices in the decoding stage, the adaptability to the prefill stage and the decoding stage can be effectively improved, and the efficiency of the reasoning process of the MoE sparse large model can be improved. By adding the first MoE layer model parameters running based on the tensor parallelism strategy to each device while the multi-head attention layer computation is performed in the prefill stage, communication overhead of a parallelism strategy change can be hidden in a layer-by-layer change mode without obviously increasing a device resource occupancy rate; after computation of the MoE layer of each architecture layer in the prefill stage is finished, the second MoE layer model parameters running based on the expert parallelism strategy can be released layer by layer, which can further avoid an increase of the device resource occupancy rate.

In order to further improve the adaptability to the decoding stage in the staged mixed parallelism reasoning process of the MoE sparse large model to further reduce the overhead of communication between the devices, in the staged mixed parallelism reasoning method for an MoE sparse large model according to the embodiment of the present disclosure, referring to FIG. 7, the following contents are further specifically included after the step 200 in the staged mixed parallelism reasoning method:
step 300: in each iteration in the decoding stage of data reasoning based on the MoE sparse large model, controlling the architecture layers of the MoE sparse large model to execute a second step layer by layer, and sending a predicted token output by the last architecture layer of the MoE sparse large model in each iteration to the multi-head attention layer in the first architecture layer of the MoE sparse large model in an AlltoAll communication mode.

All the predicted tokens are output to jointly form the predicted token string after the iterations are finished.

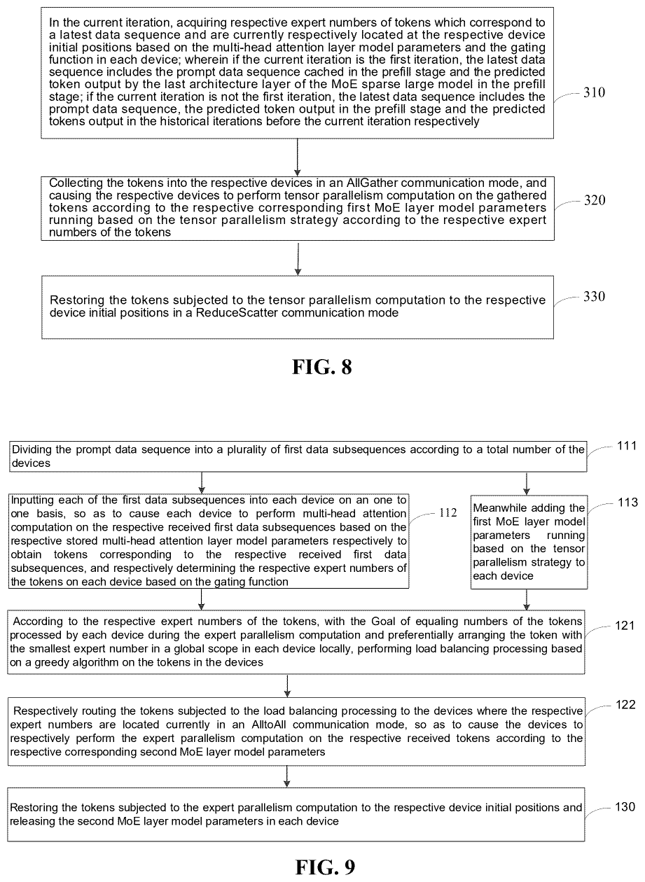

Referring to FIG. 8, the second step specifically includes the following contents:
step 310: in the current iteration, acquiring respective expert numbers of tokens which correspond to a latest data sequence and are currently respectively located at the respective device initial positions based on the multi-head attention layer model parameters and the gating function in each device; wherein if the current iteration is the first iteration, the latest data sequence includes the prompt data sequence cached in the prefill stage and the predicted token output by the last architecture layer of the MoE sparse large model in the prefill stage; if the current iteration is not the first iteration, the latest data sequence includes the prompt data sequence, the predicted token output in the prefill stage and the predicted tokens output in the historical iterations before the current iteration respectively.
Step 320: collecting the tokens into respective devices in an AllGather communication mode, and causing the respective devices to perform tensor parallelism computation on the gathered tokens according to the respective corresponding first MoE layer model parameters running based on the tensor parallelism strategy according to the respective expert numbers of the tokens.
Step 330: restoring the tokens subjected to the tensor parallelism computation to the respective device initial positions in a ReduceScatter communication mode.

In order to further improve reliability of the multi-head attention computation in the staged mixed parallelism reasoning process of the MoE sparse large model, in the staged mixed parallelism reasoning method for an MoE sparse large model according to the embodiment of the present disclosure, referring to FIG. 9, the step 110 in the staged mixed parallelism reasoning method of an MoE sparse large model specifically includes the following contents:
step 111: dividing the prompt data sequence into a plurality of first data subsequences according to a total number of the devices.
Step 112: inputting each of the first data subsequences into each device on an one to one basis, so as to cause each device to perform multi-head attention computation on the respective received first data subsequences based on the respective stored multi-head attention layer model parameters respectively to obtain tokens corresponding to the respective received first data subsequences, and respectively determining the respective expert numbers of the tokens on each device based on the gating function.

While the step 112 is executed, step 113 is executed: meanwhile adding the first MoE layer model parameters running based on the tensor parallelism strategy to each device.

Specifically, in the prefill stage, the multi-head attention layer adopts the data parallelism strategy, that is, all the input tokens are divided to the P devices for parallel processing, and the model parameters of the multi-head attention layers are replicated on the devices. After the data parallelism computation of the multi-head attention layer is finished, a result is computed according to the affinity score of the gating function.

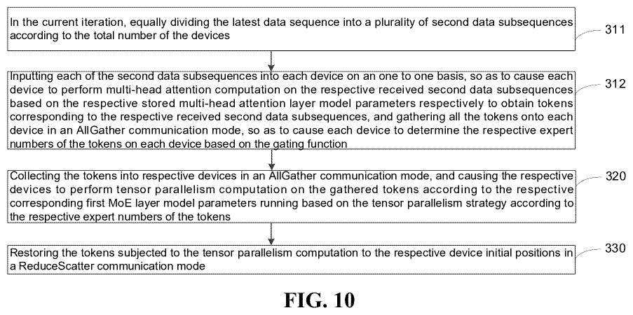

In order to further improve the reliability of the multi-head attention computation in the staged mixed parallelism reasoning process of the MoE sparse large model, in the staged mixed parallelism reasoning method for an MoE sparse large model according to the embodiment of the present disclosure, referring to FIG. 10, the step 310 in the staged mixed parallelism reasoning method of an MoE sparse large model specifically includes the following contents:
step 311: in the current iteration, equally dividing the latest data sequence into a plurality of second data subsequences according to the total number of the devices.
Step 312: inputting each of the second data subsequences into each device on an one to one basis, so as to cause each device to perform multi-head attention computation on the respective received second data subsequences based on the respective stored multi-head attention layer model parameters respectively to obtain tokens corresponding to the respective received second data subsequences, and gathering all the tokens onto each device in an AllGather communication mode, so as to cause each device to determine the respective expert numbers of the tokens on each device based on the gating function.

Specifically, in the decoding stage, the multi-head attention layer of the model adopts data parallelism, that is, all the input tokens are divided to all the devices for parallel processing, and the model parameters of the multi-head attention layers are replicated on the devices. After the data parallelism computation of the multi-head attention layer is finished, all the tokens are collected on the devices through an AllGather communication operation, and activated experts are selected according to the affinity score computation result of the gating function.

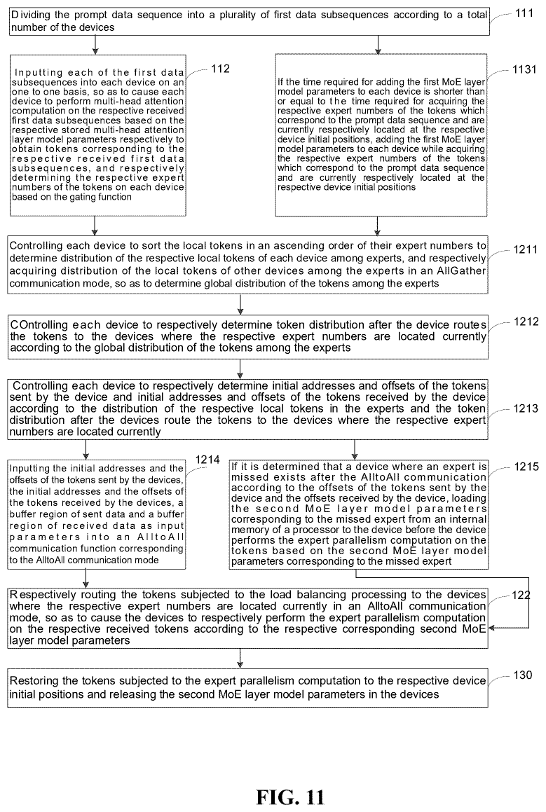

In order to further improve effectiveness and reliability of hiding of the communication overhead of the parallelism strategy change, in the staged mixed parallelism reasoning method for an MoE sparse large model according to the embodiment of the present disclosure, referring to FIG. 11, the step 113 specifically includes the following contents:
step 1131: if the time required for adding the first MoE layer model parameters to each device is shorter than or equal to the time required for acquiring the respective expert numbers of the tokens which correspond to the prompt data sequence and are currently respectively located at the respective device initial positions, adding the first MoE layer model parameters to each device while acquiring the respective expert numbers of the tokens which correspond to the prompt data sequence and are currently respectively located at the respective device initial positions.

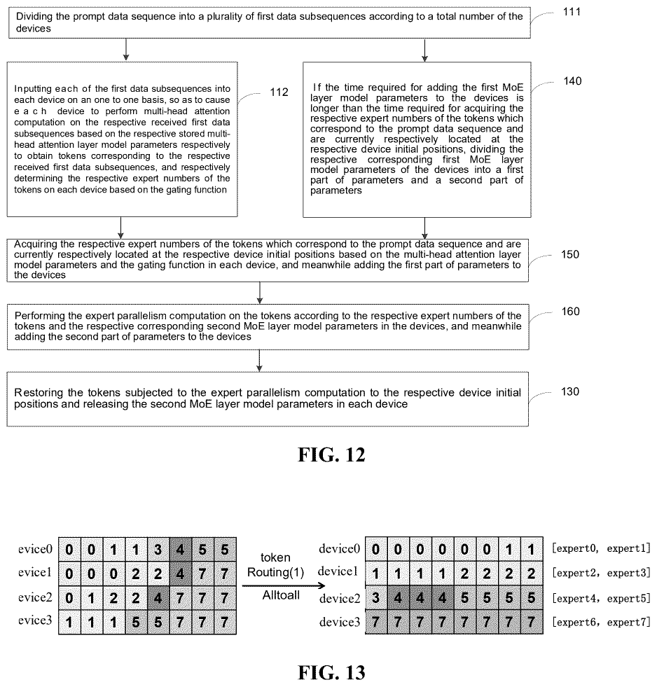

In order to further improve applicability universality and reliability of hiding of the communication overhead of the parallelism strategy change, in the staged mixed parallelism reasoning method for an MoE sparse large model according to the embodiment of the present disclosure, referring to FIG. 12, the steps 113 and 120 in the first step in the staged mixed parallelism reasoning method of an MoE sparse large model may be replaced by steps 140 to 160, which specifically include the following contents:
step 140: if the time required for adding the first MoE layer model parameters to the devices is longer than the time required for acquiring the respective expert numbers of the tokens which correspond to the prompt data sequence and are currently respectively located at the respective device initial positions, dividing the respective corresponding first MoE layer model parameters of the devices into a first part of parameters and a second part of parameters.
Step 150: acquiring the respective expert numbers of the tokens which correspond to the prompt data sequence and are currently respectively located at the respective device initial positions based on the multi-head attention layer model parameters and the gating function in each device, and meanwhile adding the first part of parameters to the devices.
Step 160: performing the expert parallelism computation on the tokens according to the respective expert numbers of the tokens and the respective corresponding second MoE layer model parameters in the devices, and meanwhile adding the second part of parameters to the devices.

That is, in the prefill stage, besides the multi-head attention layer computing process being able to hide the adding process of the first MoE layer model parameters running based on the tensor parallelism strategy, the MoE layer computing process running based on the expert parallelism strategy can also be used for hiding the adding process of the first MoE layer model parameters running based on the tensor parallelism strategy, which can be specifically determined according to estimated communication duration required for hiding the adding process of the first MoE layer model parameters.

It may be understood that the expert capacity upper limit design means that the tokens exceeding the expert capacity directly skip the MoE layer by using the residual network, and the tokens not reaching the capacity upper limit are supplemented by filling. Although this strategy can balance the computing and communication loads, the disadvantages is that it may generate useless computation and meanwhile may cause precision loss due to token discarding during reasoning, which is quite difficult to accept during reasoning. In DeepSeek V3, the load balancing strategy without auxiliary loss is used, the strategy introduces the adjustable bias value for each expert, and the bias value is added to the expert affinity score calculated by the gating function to adjust the load on each expert. The bias value is decreased for the experts with high loads and increased for the experts with low loads, which can only balance the loads on the experts as much as possible. In the prior art, the load balance is mainly optimized from an algorithm level, and the load unbalance problem cannot be thoroughly solved. That is, for distributed reasoning of the MoE sparse large model, the prior art cannot thoroughly solve the load unbalance problem of the expert parallelism.

Based on this, in order to further solve the load unbalance problem of the expert parallelism in the prefill stage, the present disclosure provides a load balancing strategy based on a greedy algorithm, and specifically, in the staged mixed parallelism reasoning method for an MoE sparse large model according to the embodiment of the present disclosure, referring to FIG. 9, the step 120 includes the following contents:
step 121: according to the respective expert numbers of the tokens, with the goal of equaling numbers of the tokens processed by each device during the expert parallelism computation and preferentially arranging the token with the smallest expert number in a global range in each device locally, performing load balancing processing based on a greedy algorithm on the tokens in the devices.
Step 122: respectively routing the tokens subjected to the load balancing processing to the devices where the respective expert numbers are located currently in an AlltoAll communication mode, so as to cause the devices to respectively perform the expert parallelism computation on the respective received tokens according to the respective corresponding second MoE layer model parameters.

That is, in the staged mixed parallelism reasoning method according to the present disclosure, the MoE layer in the decoding stage adopts the tensor parallelism which inherently has load balancing characteristics. The expert parallelism in the prefill stage still faces the load unbalance problem. Therefore, in the present disclosure, the load balancing strategy based on the greedy algorithm is provided for the expert parallelism in the prefill stage. While achieving computing and communication load balancing, the tokens with the minimum target expert numbers in the global range are preferentially and locally arranged in the device, so as to cause the experts required by the tokens to be processed on the devices to be local as far as possible (i.e., hit experts).

In order to further improve application effectiveness and reliability of the load balancing strategy based on the greedy algorithm, in the staged mixed parallelism reasoning method for an MoE sparse large model according to the embodiment of the present disclosure, referring to FIG. 11, the step 121 specifically includes the following contents:
step 1211: controlling each device to sort the local tokens in an ascending order of their expert numbers to determine distribution of the respective local tokens of each device among experts, and respectively acquiring distribution of the local tokens of other devices among the experts in an AllGather communication mode, so as to determine global distribution of the tokens among the experts.
Step 1212: controlling each device to respectively determine token distribution after the device routes the tokens to the devices where the respective expert numbers are located currently according to the global distribution of the tokens among the experts.
Step 1213: according to the distribution of respective local tokens of each device among the experts and the token distribution after each device route the tokens to the devices where the respective expert numbers are located currently, controlling each device to respectively determine initial addresses and offsets of the tokens sent by the device and initial addresses and offsets of the tokens received by the device.
Step 1214: inputting the initial addresses and the offsets of the tokens sent by the devices, the initial addresses and the offsets of the tokens received by the devices, a buffer region of sent data and a buffer region of received data as input parameters into an AlltoAll communication function corresponding to the AlltoAll communication mode.

That is, in the present disclosure, while achieving computing and communication load balancing is realized, the tokens with the minimum target expert numbers in the global range are preferentially and locally arranged in the device, so as to cause the experts required by the tokens processed on the devices to be local as far as possible (i.e., hit experts). If the required expert is not local to the device (i.e., missed expert), the missed expert is loaded onto a device video memory from a memory of a processor, such as a CPU or GPU, and overhead for loading the missed expert is hidden by computation on the hit expert. The above strategy solves the load unbalance problem from a system level, and is a precision-lossless load balancing optimization method. In addition, in the staged mixed parallelism reasoning method according to the present disclosure, the MoE layer in the decoding stage adopts the tensor parallelism which has a load balancing characteristic. Thus, the present disclosure may realize full-stage lossless load balancing of the prefill stage and the decoding stage.

However, the phenomenon that the token “misses” the local expert exists after the above load balancing token routing. For example, in the box on the right side of FIG. 13 (i.e., the grid diagram on the right side of the arrow below “token routing (1)” ), the tokens processed by “device 1” after the token routing require “expert 1” and “expert 2”, but the local experts of “device 1” are “expert 2” and “expert 3”, and “expert 1” is missed. Therefore, in order to solve the expert missing problem, the present disclosure proposes the following technical solution: all the experts are stored in the memory of the CPU in advance, and when there is s missed expert for a certain device, the missed expert can be loaded to the video memory of the device from the memory of the CPU for subsequent computation, and the expert loading overhead can be hidden by the computing and communication overhead on the hit expert.

Specifically, in the staged mixed parallelism reasoning method for an MoE sparse large model according to the embodiment of the present disclosure, referring to FIG. 11, after the step 1213, the following contents are further included:
step 1215: if it is determined that a device where an expert is missed exists after the AlltoAll communication according to the offsets of the tokens sent by the device and the offsets received by the device, loading the second MoE layer model parameters corresponding to the missed expert from a memory of a processor to the device before the device performs the expert parallelism computation on the tokens based on the second MoE layer model parameters corresponding to the missed expert.

That is, the embodiment of the present disclosure provides the staged mixed parallelism reasoning method for reasoning of the MoE sparse large model, which has a core idea that the MoE layer in the prefill stage adopts the expert parallelism, the MoE layer in the decoding stage adopts the tensor parallelism, and the multi-head attention layer in the two stages adopts the data parallelism. In the scene where the prefill stage and the decoding stage share the computing device, since the model parameters used by the devices under the expert parallelism and the tensor parallelism are different, the present disclosure proposes an efficient layer-by-layer parallelism strategy change method, and the communication overhead of the parallelism strategy change is hidden in a layer-by-layer change mode, so as to complete the efficient change from the prefill stage expert parallelism to the decoding stage tensor parallelism. Compared with the prior art, the staged mixed parallelism reasoning method according to the present disclosure has advantages, and the principle of which is as follows: the data amount processed in the prefill stage is large, the MoE layer only brings the AlltoAll communication operation when adopting the expert parallelism, the Alltoall communication amount is only a size of the input data, and the communication overhead is lower than that of the AllGather and ReduceScatter communication operations adopted in the tensor parallelism, so that the MoE layer in the prefill stage adopts the expert parallelism in the present disclosure; the data amount processed in the decoding stage is small, computing density is low, and if the MoE layer adopts the expert parallelism, a serious load unbalance problem can be caused, so that the MoE layer in the decoding stage adopts the tensor parallelism in the present disclosure, perfect load balance can be realized, an input data amount in the decoding stage is low, a communication delay is limited, and a lower communication delay can be obtained by adopting the tensor parallelism. The staged mixed parallelism strategy can have the performance advantages of adopting the expert parallelism in the MoE layer in the prefill stage and adopting the tensor parallelism in the MoE layer in the decoding stage. In the scene where the computing device is shared by the prefill stage and the decoding stage, the present disclosure provides the efficient layer-by-layer parallelism strategy change method, so as to realize the efficient change of the parallelism strategies between the two stages.

In order to solve the load unbalance problem of the expert parallelism in the prefill stage, the embodiment of the present disclosure further provides the load balancing strategy based on the greedy algorithm, so as to solve the load unbalance problem from the system level. The load balancing strategy has a principle that, as shown in FIG. 2, in the expert parallelism in the prefill stage, the dynamic routing of the tokens can cause the load unbalance problem. In order to realize load balancing, if some of the tokens on the high-load device are directly distributed to the low-load device to be processed, it is necessary to migrate the corresponding experts to the low-load device, which causes expert migration overhead. The present disclosure provides the load balancing strategy based on the greedy algorithm, while achieving computing and communication load balancing, the tokens with the minimum target expert numbers in the global range are preferentially and locally arranged in the device, so as to cause the experts required by the tokens to be processed on the devices to be local as far as possible (i.e., hit experts). If the required expert is not local to the device (i.e., missed expert), the missed expert is loaded onto the device video memory from the memory of the CPU, and the overhead for loading the missed expert is hidden by the computation on the hit expert. The above strategy solves the load unbalance problem from the system level, and is a precision-lossless load balancing optimization method.

In order to further explain the staged mixed parallelism reasoning method for an MoE sparse large model according to the above embodiment, the present disclosure further provides a specific application example of the staged mixed parallelism reasoning method for an MoE sparse large model, and the application example is used to solve the following technical problems in the prior art.

(1) For distributed reasoning of an MoE sparse large model, a parallelism strategy adopted in the prior art, especially a PD-integrated reasoning solution, has poor adaptability to a prefill stage and a decoding stage. A typical example is a mixed parallelism strategy of “data parallelism+tensor parallelism+expert parallelism” adopted by DeepSpeed-MoE, the parallelism strategy does not distinguish the prefill stage from the decoding stage, and the parallelism strategy of the whole reasoning process is constant. However, the prefill stage has a large processed data amount, data AllGather and ReduceScatter communication operations can be brought when the tensor parallelism is adopted, and communication overhead is high, which is more serious when a large amount of data is processed. The decoding stage has a relatively small processed data amount, a load unbalance problem may be caused when the expert parallelism is adopted, the decoding stage has low computing density and a small processed data amount, and AlltoAll communication overhead brought by the expert parallelism is more obvious.

Therefore, the present disclosure provides a staged mixed parallelism reasoning method of an MoE sparse large model. For the prefill stage with a high processed data amount, an MoE layer adopts the expert parallelism with a relatively lower communication amount. For the decoding stage with a low processed data amount, the MoE layer adopts the more efficient tensor parallelism. For a multi-head attention layer, the two stages adopt the data parallelism. Since the prefill stage and the decoding stage adopt different parallelism strategies at the MoE layer, and model parameters used by each device in the two stages are different, a parallelism strategy change needs to be performed between the two stages, that is, the model parameters required by the decoding stage need to be loaded after prefill execution is finished. The present disclosure provides an efficient layer-by-layer parallelism strategy change mode, which hides the communication overhead of the parallelism strategy change in a layer-by-layer change mode.

(2) For distributed reasoning of the MoE sparse large model, the prior art cannot thoroughly solve the load unbalance problem of the expert parallelism. Gshard proposes an expert capacity upper limit design, that is, tokens exceeding an expert capacity directly skip the MoE layer by using a residual network, and tokens not reaching a capacity upper limit are supplemented by filling. Although this strategy can balance computing and communication loads, it has the disadvantages of generating useless computation and meanwhile causing precision loss due to token discarding during reasoning, which is quite difficult to accept during reasoning. In DeepSeek V3, a load balancing strategy without auxiliary loss is used, the strategy introduces an adjustable bias value for each expert, and the bias value is added to an expert affinity score calculated by a gating function to adjust a load on each expert. The bias value is decreased for the experts with high loads and increased for the experts with low loads, which can only balance the loads on the experts as much as possible. In the prior art, the load balance is mainly optimized from an algorithm level, and the load unbalance problem cannot be thoroughly solved.

In order to solve the load unbalance problem of the expert parallelism in the prefill stage, the present disclosure provides a load balancing strategy based on a greedy algorithm. While achieving computing and communication load balancing is realized, tokens with minimum target expert numbers in a global range are preferentially and locally arranged in the device, so as to cause the experts required by the tokens processed on the devices to be local as far as possible (i.e., hit experts). If the required expert is not local to the device (i.e., missed expert), the missed expert is loaded onto a device video memory from a memory of a CPU, and overhead for loading the missed expert is hidden by computation on the hit expert. The above strategy solves the load unbalance problem from a system level, and is a precision-lossless load balancing optimization method. In addition, in the staged mixed parallelism reasoning method according to the present disclosure, the MoE layer in the decoding stage adopts the tensor parallelism which has a load balancing characteristic. Thus, the present disclosure may realize full-stage lossless load balancing of the prefill stage and the decoding stage.

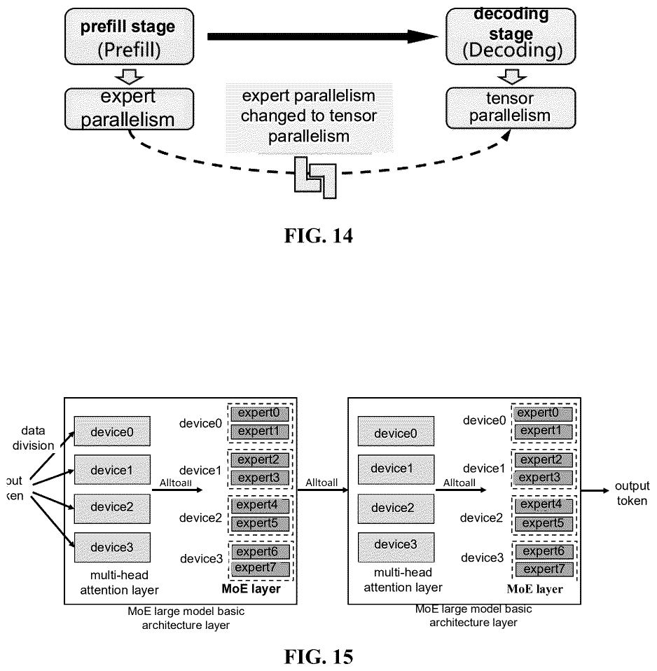

Based on this, referring to FIG. 14, a core MoE layer staged mixed parallelism strategy involved in the staged mixed parallelism reasoning method for an MoE sparse large model in the application example of the present disclosure is as follows.

### 1. Staged Mixed Parallelism Strategy for Reasoning of MoE Sparse Large Model

The application example of the present disclosure provides a staged mixed parallelism strategy for reasoning of the MoE sparse large model, and the overall solution is shown in FIG. 14, in which the MoE layer in the prefill stage adopts the expert parallelism, the MoE layer in the decoding stage adopts the tensor parallelism, the multi-head attention layer in the two stages adopts the data parallelism, and the efficient layer-by-layer parallelism strategy change method is adopted between the two stages to realize the efficient change of the parallelism strategies between the two stages. A specific technical solution of the staged mixed parallelism strategy is as follows.

1-1. Parallelism strategy of prefill stage: referring to FIG. 15, for the prefill stage, the MoE layer of the model adopts the expert parallelism, that is, all E experts are equally divided to P devices, a high feature dimension of each expert is set to H, the expert owned by each device is set to [E/P, H], E/P is a number of the experts on each device, and each device processes the routed tokens; the multi-head attention layer of the model adopts the data parallelism, that is, all input tokens are divided to the P devices to be processed in parallel, and model parameters of the multi-head attention layer are copied on each device. After data parallelism computation of the multi-head attention layer is finished, according to an affinity score computation result of the gating function, the tokens are routed to the device where the corresponding experts are located through an AlltoAll communication operation, and expert parallelism computation of the MoE layer is performed. After completion of the expert parallelism computation of the MoE layer, the tokens are routed back to the initial devices through an AlltoAll communication operation, so as to perform data parallelism computation of the multi-head attention layer of the next layer.

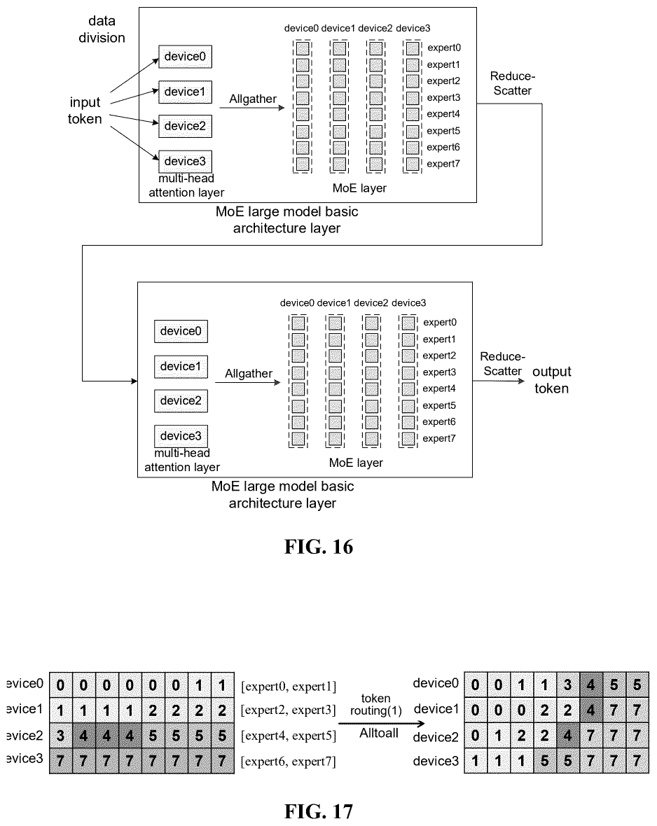

1-2. Parallelism strategy of decoding stage: referring to FIG. 16, for the decoding stage, the tensor parallelism is adopted in the MoE layer of the model, that is, the high feature dimensions H of all the E experts are averagely divided to the P devices, the expert owned by each device is [E, H/P], that is, each device owns H/P of all the E experts, and each device needs to process all tokens; the multi-head attention layer of the model adopts the data parallelism, that is, all the input tokens are divided to the devices to be processed in parallel, and the model parameters of the multi-head attention layer are copied on each device. After the data parallelism computation of the multi-head attention layer is finished, all the tokens are collected on the devices through an AllGather communication operation, activated experts are selected according to the affinity score computation result of the gating function, and then, local computation of the tensor parallelism of the MoE layer is performed by taking all the tokens and the activated experts as input. After the local computation of the tensor parallelism of the MoE layer is finished, the local computation result is reduced and scattered through a ReduceScatter communication operation, so as to perform data parallelism computation of the multi-head attention layer of the next layer.

1-3. Method of layer-by-layer parallelism strategy change between prefill stage and decoding stage: the MoE layer in the prefill stage adopts the expert parallelism, and the MoE layer is divided according to the number and dimension of the experts; and the MoE layer in the decoding stage adopts the tensor parallelism, and the MoE layer is divided according to the high feature dimensions of the experts. The prefill and decoding stages use different model parameters at the MoE layer, and preparing two sets of model parameters in the video memory at the same time significantly increases video memory overhead. Therefore, the application example of the present disclosure provides an efficient layer-by-layer parallelism strategy change mode, which hides the communication overhead of the parallelism strategy change in a layer-by-layer change mode. It is assumed that the model has L MoE model basic architectures (as shown in FIG. 1), when computation of each MoE model basic architecture is executed, model parameter distribution of the expert parallelism of the MoE layer of the current basic architecture is changed into model parameter distribution of the tensor parallelism of the MoE layer of the current basic architecture through the AlltoAll communication operation, and after the AlltoAll communication operation and the computation of the current MoE layer are finished, the model parameters required by the expert parallelism of the MoE layer in the video memory are released to complete the parallelism strategy change of the current layer. The parallelism strategy change of the L layers is completed in sequence according to the above method, and then, the parallelism strategy changes from the prefill stage to the decoding stage of the whole model is completed.

### 2. Load Balancing Strategy Based on Greedy Algorithm

In the staged mixed parallelism reasoning method in the application example of the present disclosure, the MoE layer in the decoding stage adopts the tensor parallelism which has a load balancing characteristic. The expert parallelism in the prefill stage still faces the load unbalance problem. Therefore, in the application example of the present disclosure, the load balancing strategy based on the greedy algorithm is provided for the expert parallelism in the prefill stage, and the tokens with the minimum target expert numbers in the global range are preferentially and locally distributed in the device while computing and communication load balancing is realized, so as to cause the experts required by the tokens processed on the devices to be local as far as possible (i.e., hit experts). Specifically, in a first step, a target expert number of each input token is calculated according to the gating function, the local input tokens of each device are sorted, and tokens with small target expert numbers are arranged in the front, as shown in the box on the left side in FIG. 13 (i.e., the grid diagram on the left side of the arrow below “token routing (1)” ), so as to determine distribution of the local input tokens in the experts before AlltoAll token routing; in a second step, a token distribution target after AlltoAll token routing of each device is determined, two targets need to be achieved, numbers of the tokens processed by the devices are guaranteed to be equal to realize load balancing, and meanwhile, the tokens with the minimum target expert numbers in the global range are preferentially and locally distributed in the device, so as to cause the tokens processed by each device to hit the local experts as far as possible; in a third step, in order to achieve the above-mentioned target, each device counts the distribution of the local input tokens in the experts, and each device collects the distribution of all the input tokens in the experts by using the AllGather communication operation, thereby calculating the total number of the tokens processed by each expert in the global range; in a fourth step, according to the global distribution of the tokens in each expert, each device determines the token distribution after AlltoAll token routing, the total number of the input tokens is set to N, the number of the devices is set to P, the tokens with the minimum target expert numbers in the global range are preferentially and locally distributed in the devices to fully arrange N/P tokens from the device with the minimum number, the distribution in the next device is then performed until the distribution in the P devices is completed, and the token distribution effect after routing is shown in the box on the right side in FIG. 13 (i.e., the grid diagram on the right side of the arrow below “token routing (1)”); in a fifth step, an initial address and an offset of the token sent by each device and an initial address and an offset of the received token in the AlltoAll communication operation are calculated according to the obtained distribution of the local input tokens on the experts before the AlltoAll token routing and the token distribution after the AlltoAll token routing; and in a six step, the initial addresses and the offsets of the sent and received data obtained through the computation in the fifth step, a sent data buffer region and a received data buffer region are input into an AlltoAll communication function as input parameters, and then, the AlltoAll communication operation is performed to complete load-balanced token routing.

An example of load-balanced token routing implemented according to the above technical solution is shown in FIG. 13. The numbers of the tokens processed by the devices after routing are the same, and computing load balancing is realized. Meanwhile, in the AlltoAll communication operation, all the devices send the same total amount of data, and receive the same total amount of data, so that communication load balancing of endpoints is realized. However, the phenomenon that the token “misses” the local expert exists after the above load balancing token routing. For example, in the box on the right side of FIG. 13 (i.e., the grid diagram on the right side of the arrow below “token routing (1)” ), the tokens processed by “device 1” after the token routing require “expert 1” and “expert 2”, but the local experts of “device 1” are “expert 2” and “expert 3”, and “expert 1” is missed. In order to solve the expert missing problem, the application example of the present disclosure proposes the following technical solution: all the experts are stored in the memory of the CPU in advance, and when there is s missed expert for a certain device, the missed expert can be loaded to the video memory of the device from the memory of the CPU for subsequent computation, and the expert loading overhead can be hidden by the computing and communication overhead on the hit expert.

After completion of the expert parallelism computation of the MoE layer, the tokens are routed back to the initial devices through an opposite AlltoAll communication operation, so as to perform data parallelism computation of the multi-head attention layer of the next layer, as shown in FIG. 17. In the AlltoAll communication operation, all the devices send the same total amount of data, and receive the same total amount of data, so that communication load balancing of the endpoints is also realized.

The above load balancing technical solution in the application example of the present disclosure ensures that model precision is lossless while realizing computing and communication load balancing, and the load balance problem is thoroughly solved from the system level. Meanwhile, in the staged mixed parallelism reasoning method in the application example of the present disclosure, the MoE layer in the decoding stage adopts the tensor parallelism which has a load balancing characteristic. Thus, the application example of the present disclosure may realize full-stage lossless load balancing of the prefill stage and the decoding stage.

### 3. Data Transmission Overhead Hiding Technology

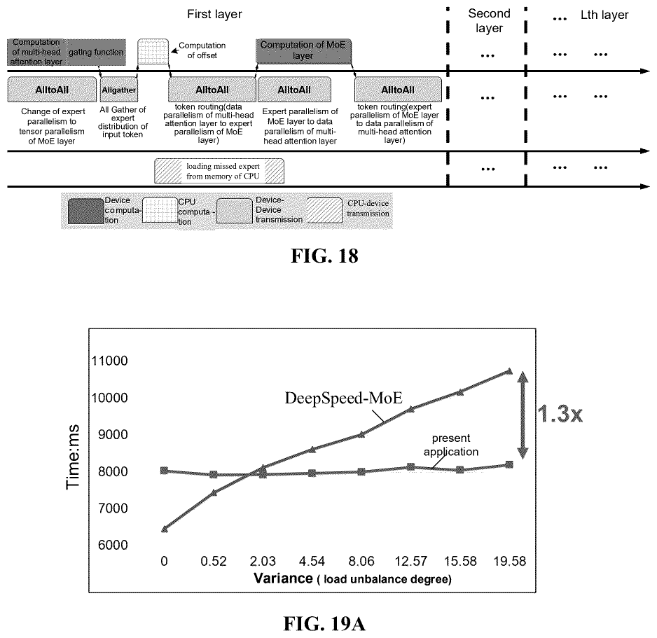

In the above staged mixed parallelism technical solution for reasoning of the MoE sparse large model, the layer-by-layer parallelism strategy change of the MoE layer from the prefill stage to the decoding stage needs to be completed through the AlltoAll communication operation. In the technical solution of the load balancing strategy based on the greedy algorithm, the missed expert needs to be loaded onto the device video memory from the memory of the CPU. The layer-by-layer parallelism strategy change and missed expert loading can bring data transmission overhead. The application example of the present disclosure provides a data transmission overhead hiding technology, which hides the data transmission overhead caused by the layer-by-layer parallelism strategy change and missed expert loading through irrelevant computing and communication loads, and the technical solution is shown in FIG. 18. The AlltoAll communication overhead brought by the parallelism strategy change (change from the expert parallelism to the tensor parallelism) of the MoE layer is covered by computing loads, such as multi-head attention layer computation, gate function computation and MoE layer computation. The data transmission overhead brought by the missed expert loading is hidden by the loads, such as AlltoAll communication of token routing from the data parallelism of the multi-head attention layer to the expert parallelism of the MoE layer, MoE layer computation on the hit experts, and offset computation.

In addition, in the application example of the present disclosure, a corresponding experimental test is performed, and specific contents are as follows.

The experimental test was performed on a 2-computer 16-card Ascend 910B distributed machine, a single-card video memory of Ascend 910B having a capacity of 64GB. A test object is a DeepSeek V2 MoE sparse large model (model parameter quantity: 236 billion), and a comparison baseline is a DeepSpeed-MoE parallelism framework.

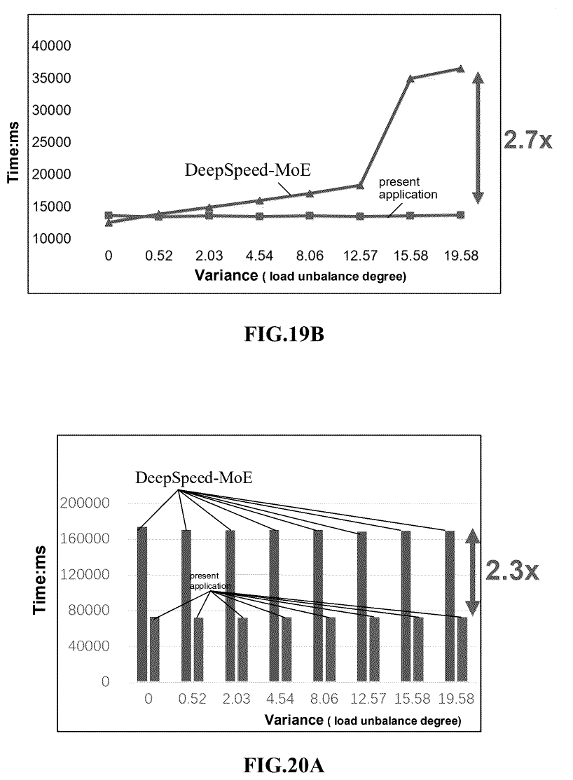

FIG. 19(a) and 19B show performance results of DeepSeek-V2 in the prefill stage under the cases that batchsize=128 and batchsize=256 respectively, the abscissa being a load unbalance degree (represented by a variance). Test results show that the load balancing strategy based on the greedy algorithm in the application example of the present disclosure can effectively solve the load unbalance problem of the MoE sparse large model, and an execution time in the prefill stage is hardly influenced by the load unbalance degree. Compared with the baseline DeepSpeed-MoE framework, the performance advantages of the application example of the present disclosure are more obvious with an increase of the load unbalance degree, and a maximum 2.7-fold performance acceleration ratio is obtained. The above performance test result verifies effectiveness of the load balancing strategy based on the greedy algorithm in the present disclosure.

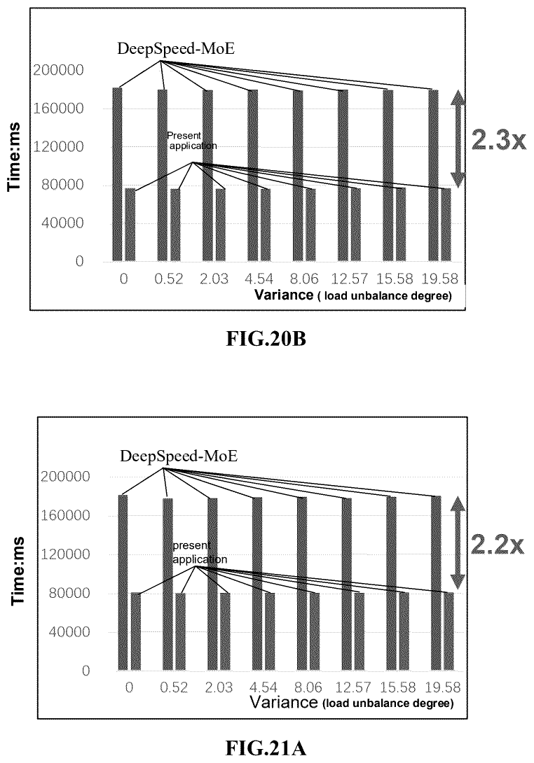

FIGS. 20A and 20B show performance results of DeepSeek-V2 in the decoding stage under the cases that batchsize=128 and batchsize=256 respectively, the abscissa being the load unbalance degree. Test results show that the tensor parallelism is adopted in the decoding stage in the staged mixed parallelism strategy in the application example of the present disclosure, and a 2.3-fold performance acceleration ratio is obtained compared with the expert parallelism strategy adopted by baseline DeepSpeed-MoE, so that rationality and effectiveness of the tensor parallelism adopted in the decoding stage in the staged mixed parallelism strategy in the application example of the present disclosure are proved.

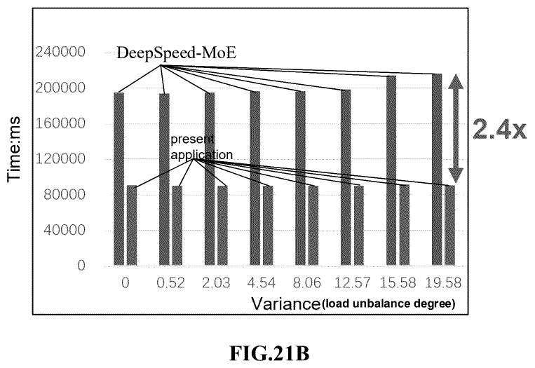

FIGS. 21A and 21B show performance results of DeepSeek-V2 in end-to-end reasoning (including the prefill and decoding stages) under the cases that batchsize=128 and batchsize=256 respectively, the abscissa being the load unbalance degree. Test results show that compared with the parallelism strategy which is adopted by baseline DeepSpeed-MoE and is constant in the whole reasoning process, the staged mixed parallelism reasoning method and system of an MoE sparse large model in the application example of the present disclosure can obtain a maximum 2.4-fold performance acceleration ratio. In the end-to-end reasoning, the system of the application example of the present disclosure integrates all the proposed technical solutions, including the staged mixed parallelism strategy of reasoning of the MoE sparse large model, the load balancing strategy based on the greedy algorithm and the data transmission overhead hiding technology, and the effectiveness of the technical solution proposed by the application example of the present disclosure can be verified by the end-to-end reasoning performance result.

In conclusion, compared with the prior art, the staged mixed parallelism reasoning method of an MoE sparse large model in the application example of the present disclosure has the following beneficial effects.

(1) The parallelism strategy adopted in the prior art does not fully consider computing load characteristics of the prefill and decoding stages, and the staged mixed parallelism strategy in the present disclosure better adapts to the computing load characteristics of the prefill and decoding stages in the reasoning process of the MoE sparse large model, and has the following advantages compared with the prior art: in the staged mixed parallelism strategy in the disclosure, the expert parallelism is adopted by the MoE layer in the prefill stage, the communication amount of the Alltoall operation brought by the expert parallelism is only the size of the input data, and the communication overhead is lower than that of the AllGather and ReduceScatter communication operations adopted by the tensor parallelism; in the disclosure, the tensor parallelism is adopted by the MoE layer in the decoding stage, so that full load balancing in the aspects of computation, memory access and communication can be realized, and meanwhile, the input data amount in the decoding stage is low, the communication delay is limited, and the lower communication delay can be obtained by adopting the tensor parallelism; the efficient layer-by-layer parallelism strategy change method is adopted, the communication overhead of the parallelism strategy change is hidden in the layer-by-layer change mode, so that the efficient change from the expert parallelism in the prefill stage to the tensor parallelism in the decoding stage is completed, and the performance advantages of adopting the expert parallelism in the MoE layer in the prefill stage and adopting the tensor parallelism in the MoE layer in the decoding stage are achieved. In summary, the staged mixed parallelism reasoning method according to the disclosure adopts different adaptive parallelism strategies for different stages, and realizes efficient connection through the layer-by-layer parallelism strategy change method, so that a better performance can be achieved compared with the prior art.

(2) For the load balancing problem of the MoE sparse large model, optimization is mainly performed from the model algorithm level in the prior art, such as the expert capacity upper limit strategy of Gshard and the load balancing strategy of DeepSeek V3 without auxiliary loss. However, the prior art cannot solve the load balancing problem fundamentally, brings the model precision loss, or still has certain load unbalance. For the load unbalance problem of the expert parallelism in the prefill stage, the present disclosure provides the load balancing strategy based on the greedy algorithm, computing and communication load balancing is achieved, and meanwhile, the model precision is guaranteed to be lossless, and the load balancing problem is thoroughly solved from the system level. Meanwhile, in the staged mixed parallelism reasoning method according to the present disclosure, the MoE layer in the decoding stage adopts the tensor parallelism which has a load balancing characteristic. Thus, the present disclosure may realize full-stage lossless load balancing of the prefill stage and the decoding stage.

In terms of software, the present disclosure further provides a staged mixed parallelism reasoning apparatus of an MoE sparse large model for implementing all or part of the staged mixed parallelism reasoning method of an MoE sparse large model, and the staged mixed parallelism reasoning apparatus of an MoE sparse large model specifically includes the following contents:
a prefill stage executing module configured to, in a prefill stage of data reasoning based on the MoE sparse large model, control architecture layers of the MoE sparse large model to execute a first step layer by layer; wherein the first step includes: acquiring respective expert numbers of tokens which correspond to a prompt data sequence and are currently respectively located at respective device initial positions based on multi-head attention layer model parameters in devices and a gating function, and meanwhile adding first MoE layer model parameters running based on a tensor parallelism strategy to the devices; then performing expert parallelism computation on the tokens according to the respective expert numbers of the tokens and respective corresponding second MoE layer model parameters in the devices running based on an expert parallelism strategy; and then restoring the tokens subjected to the expert parallelism computation to the respective device initial positions and releasing the second MoE layer model parameters in the devices; and
a stage change executing module configured to send a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters in the devices, the gating function and the first MoE layer model parameters in the devices running based on the tensor parallelism strategy.

In some embodiments of the present disclosure, the staged mixed parallelism reasoning apparatus of an MoE sparse large model further includes the following module executed behind the stage change executing module:
a decoding stage executing module configured to, in each iteration in the decoding stage of data reasoning based on the MoE sparse large model, control the architecture layers of the MoE sparse large model to execute a second step layer by layer, and send a predicted token output by the last architecture layer of the MoE sparse large model in each iteration to the multi-head attention layer in the first architecture layer of the MoE sparse large model in an AlltoAll communication mode.

The embodiment of the staged mixed parallelism reasoning apparatus of an MoE sparse large model according to the disclosure can be specifically configured to execute the processing flow of the embodiment of the staged mixed parallelism reasoning method of an MoE sparse large model according to the above embodiment, the functions thereof are not repeated herein, and reference can be made to the detailed description of the embodiment of the staged mixed parallelism reasoning method of an MoE sparse large model.

A part of the staged mixed parallelism reasoning apparatus of an MoE sparse large model for performing staged mixed parallelism reasoning of the MoE sparse large model can be implemented in a server or client device. Specific selection may be performed according to a processing capability of the client device, a limitation of a user usage scenario, or the like, which is not limited in the present disclosure. If all operations are completed in the client device, the client device may further include a processor for specific processing of staged mixed parallelism reasoning of the MoE sparse large model.

The client device may have a communication module (i.e., a communication unit) and may be communicatively connected to a remote server to implement data transmission with the server. The server may include a server on a task scheduling center side, and in other implementation scenarios, the server may further include a server of an intermediate platform, for example, a server of a third-party server platform communicatively linked with the task scheduling center server. The server may include a single computer device, or may include a server cluster formed by a plurality of servers, or has a distributed server structure.

The server and the client device may be communicated using any suitable network protocol, including network protocols not developed at the filing date of the present disclosure. The network protocol may include, for example, a TCP/IP protocol, a UDP/IP protocol, an HTTP protocol, an HTTPS protocol, or the like. Certainly, the network protocol may further include, for example, a remote procedure call (RPC) protocol, a representational state transfer (REST) protocol, or the like, used above the above protocol.

From the above description, it can be learnt that, in the staged mixed parallelism reasoning apparatus of an MoE sparse large model according to the embodiment of the present disclosure, for the prefill stage with the high processed data amount, the MoE layer adopts the expert parallelism strategy with the relatively lower communication amount to effectively reduce the overhead of communication among the devices in the prefill stage. For the decoding stage with the low processed data amount, the MoE layer adopts the more efficient tensor parallelism strategy to effectively reduce the overhead of communication among the devices in the decoding stage, the adaptability to the prefill stage and the decoding stage can be effectively improved, and the efficiency of the reasoning process of the MoE sparse large model can be improved. By adding the first MoE layer model parameters running based on the tensor parallelism strategy to the devices while the multi-head attention layer computation is performed in the prefill stage, communication overhead of a parallelism strategy change can be hidden in a layer-by-layer change mode without obviously increasing a device resource occupancy rate; after computation of the MoE layer of each architecture layer in the prefill stage is finished, the second MoE layer model parameters running based on the expert parallelism strategy can be released layer by layer, which can further avoid an increase of the device resource occupancy rate.

An embodiment of the present disclosure further provides an electronic device, which may include a processor, a memory, a receiver, and a transmitter, wherein the processor is configured to execute the staged mixed parallelism reasoning method of an MoE sparse large model according to the above embodiment, and the processor and the memory may be connected by a bus or in another mode, for example, connected by a bus. The receiver can be connected with the processor and the memory in a wired or wireless mode.

The processor may be a central processing unit (CPU). The processor may be another general purpose processor, a digital signal processor (DSP), an application specific integrated circuit (ASIC), a field-programmable gate array (FPGA) or another programmable logic device, discrete gate or transistor logic device, discrete hardware component, or a combination thereof.

As a non-transitory computer-readable storage medium, the memory may be configured to store non-transitory software programs, non-transitory computer-executable programs, and modules, such as program instructions/modules corresponding to the staged mixed parallelism reasoning method of an MoE sparse large model according to the embodiments of the present disclosure. The processor runs the non-transitory software programs, instructions and modules stored in the memory to execute various functional applications and data processing of the processor, that is, implement the staged mixed parallelism reasoning method of an MoE sparse large model according to the above method embodiments.

The memory may include a program storage region and a data storage region, and the program storage region may store an operating system, and an application required by at least one function; the data storage region may store data created by the processor, or the like. Furthermore, the memory may include a high speed random access memory, and may also include a non-transitory memory, such as at least one disk storage device, a flash memory device, or another non-transitory solid state storage device. In some embodiments, the memory optionally includes memories located remotely from the processor, and such remote memories may be connected to the processor through a network. Examples of such a network include, but are not limited to, the Internet, intranets, local area networks, mobile communication networks, and combinations thereof.

The one or more modules are stored in the memory and, when executed by the processor, perform the staged mixed parallelism reasoning method of an MoE sparse large model according to the embodiment.

In some embodiments of the present disclosure, a user device may include a processor, a memory, and a transceiving unit, wherein the transceiving unit may include a receiver and a transmitter, the processor, the memory, the receiver, and the transmitter may be connected through a bus system, the memory is configured to store computer instructions, and the processor is configured to execute computer instructions stored in the memory to control the transceiving unit to transceive signals.

As an implementation, functions of the receiver and the transmitter in the present disclosure may be considered to be achieved by a transceiving circuit or a transceiving dedicated chip, and the processor may be considered to be implemented by a dedicated processing chip, a processing circuit or a general purpose chip.

As another implementation, the server in the embodiment of the present disclosure may be implemented by using a general purpose computer. That is, program codes that achieve the functions of the processor, the receiver and the transmitter are stored in the memory, and the general purpose processor achieves the functions of the processor, the receiver and the transmitter by executing the codes in the memory.

An embodiment of the present disclosure further provides a staged mixed parallelism reasoning system of an MoE sparse large model, at least including: a scheduling apparatus and devices in communication connection with the scheduling apparatus; wherein the scheduling apparatus includes a memory, a processor and a computer program stored in the memory and operable on the processor, and when the processor executes the computer program, the staged mixed parallelism reasoning method of an MoE sparse large model according to the above embodiment is implemented.

An embodiment of the present disclosure further provides a computer-readable storage medium having a computer program stored thereon, the computer program, when executed by a processor, implementing the steps of the staged mixed parallelism reasoning method of an MoE sparse large model. The computer-readable storage medium may be a tangible storage medium, such as a random access memory (RAM), a memory, a read only memory (ROM), an electrically programmable ROM, an electrically erasable programmable ROM, a register, a floppy disk, a hard disk, a removable storage disk, a CD-ROM, or any other form of storage medium known in the art.

An embodiment of the present disclosure further provides a computer program product, including a computer program, the computer program, when executed by a processor, implementing the steps of the staged mixed parallelism reasoning method of an MoE sparse large model.

Those of ordinary skill in the art should appreciate that the various exemplary components, systems and methods described in connection with the embodiments disclosed herein may be implemented in hardware, software, or combinations thereof. Whether they are implemented in hardware or software depends upon particular applications and design constraints of the technical solution. Professionals may use different methods for particular applications to achieve the described functions, but such implementations should not be considered beyond the scope of the present disclosure. When implemented in hardware, the elements of the present invention may be, for example, an electronic circuit, an application specific integrated circuit (ASIC), suitable firmware, plug-in, a function card, or the like. When implemented in software, the elements of the present disclosure are programs or code segments used to perform required tasks. The programs or the code segments can be stored in a machine-readable medium or transmitted by a data signal carried in a carrier wave over a transmission medium or a communication link.

It is to be understood that the present disclosure is not limited to the particular configurations and processing described above and shown in the drawings. A detailed description of known methods is omitted herein for the sake of brevity. In the above embodiments, several specific steps are described and shown as an example. However, the method processes of the present disclosure are not limited to the specific steps described and shown, and those skilled in the art can make various changes, modifications and additions, or change the order between the steps, after comprehending the spirit of the present disclosure.

Features that are described and/or illustrated with respect to one embodiment may be used in the same way or in a similar way in one or more other embodiments and/or in combination with or instead of the features of the other embodiments in the present disclosure.

The above description is only a preferred embodiment of the present disclosure and is not intended to limit the present disclosure, and various modifications and changes may be made to the embodiment of the present disclosure by those skilled in the art. Any modifications, equivalents and improvements made within the spirit and principle of the present disclosure should be included in the protection scope of the present disclosure.

1. A staged mixed parallelism reasoning method for an MoE sparse large model, comprising:
in a prefill stage of data reasoning based on the MoE sparse large model, controlling architecture layers of the MoE sparse large model to execute a first step layer by layer; wherein the first step comprises: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device ; and then restoring the tokens subjected to the expert parallelism computation to the respective device initial positions and releasing the second MoE layer model parameters in each device; wherein the first MoE layer model parameters run based on a tensor parallelism strategy, and the second MoE layer model parameters run based on an expert parallelism strategy; and
sending a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.

2. The staged mixed parallelism reasoning method for an MoE sparse large model according to claim 1, further comprising:
in each iteration in the decoding stage of data reasoning based on the MoE sparse large model, controlling the architecture layers of the MoE sparse large model to execute a second step layer by layer, and sending a predicted token output by the last architecture layer of the MoE sparse large model in each iteration to the multi-head attention layer in the first architecture layer of the MoE sparse large model in an AlltoAll communication mode;
wherein the second step comprises:
in the current iteration, acquiring respective expert numbers of tokens which correspond to a latest data sequence and are currently respectively located at the respective device initial positions based on the multi-head attention layer model parameters and the gating function in each device; wherein if the current iteration is the first iteration, the latest data sequence comprises the prompt data sequence cached in the prefill stage and the predicted token output by the last architecture layer of the MoE sparse large model in the prefill stage; if the current iteration is not the first iteration, the latest data sequence comprises the prompt data sequence, the predicted token output in the prefill stage and the predicted tokens output in the historical iterations before the current iteration respectively;
collecting the tokens into respective devices in an AllGather communication mode, and causing the respective devices to perform tensor parallelism computation on the gathered tokens according to the respective corresponding first MoE layer model parameters running based on the tensor parallelism strategy according to the respective expert numbers of the tokens; and
restoring the tokens subjected to the tensor parallelism computation to the respective device initial positions in a ReduceScatter communication mode.

3. The staged mixed parallelism reasoning method for an MoE sparse large model according to claim 2, wherein the acquiring respective expert numbers of tokens which correspond to a prompt data sequence and are currently respectively located at respective device initial positions based on multi-head attention layer model parameters and a gating function in each device comprises:
dividing the prompt data sequence into a plurality of first data subsequences according to a total number of the devices; and
inputting each of the first data subsequences into each device on an one to one basis, so as to cause each device to perform multi-head attention computation on the respective received first data subsequences based on the respective stored multi-head attention layer model parameters respectively to obtain tokens corresponding to the respective received first data subsequences, and respectively determining the respective expert numbers of the tokens on each device based on the gating function;
the acquiring respective expert numbers of tokens which correspond to a latest data sequence and are currently respectively located at the respective device initial positions based on the multi-head attention layer model parameters and the gating function in each device comprises:
equally dividing the latest data sequence into a plurality of second data subsequences according to the total number of the devices; and
inputting each of the second data subsequences into each device on an one to one basis, so as to cause each device to perform multi-head attention computation on the respective received second data subsequences based on the respective stored multi-head attention layer model parameters respectively to obtain tokens corresponding to the respective received second data subsequences, and gathering all the tokens onto each device in an AllGather communication mode, so as to cause each device to determine the respective expert numbers of the tokens on each device based on the gating function.

4. The staged mixed parallelism reasoning method for an MoE sparse large model according to claim 1, wherein the meanwhile adding first MoE layer model parameters to each device comprises:
if the time required for adding the first MoE layer model parameters to each device is shorter than or equal to the time required for acquiring the respective expert numbers of the tokens which correspond to the prompt data sequence and are currently respectively located at the respective device initial positions, adding the first MoE layer model parameters to each device while acquiring the respective expert numbers of the tokens which correspond to the prompt data sequence and are currently respectively located at the respective device initial positions.

5. The staged mixed parallelism reasoning method for an MoE sparse large model according to claim 1, before restoring the tokens subjected to the expert parallelism computation to the respective device initial positions in the first step, further comprising:
if the time required for adding the first MoE layer model parameters to each device is longer than the time required for acquiring the respective expert numbers of the tokens which correspond to the prompt data sequence and are currently respectively located at the respective device initial positions, dividing the respective corresponding first MoE layer model parameters of each device into a first part of parameters and a second part of parameters;
acquiring the respective expert numbers of the tokens which correspond to the prompt data sequence and are currently respectively located at the respective device initial positions based on the multi-head attention layer model parameters and the gating function in each device, and meanwhile adding the first part of parameters to each device; and
then performing the expert parallelism computation on the tokens according to the respective expert numbers of the tokens and the respective corresponding second MoE layer model parameters in each device, and meanwhile adding the second part of parameters to each device.

6. The staged mixed parallelism reasoning method for an MoE sparse large model according to claim 1, wherein the performing the expert parallelism computation on the tokens according to the respective expert numbers of the tokens and the respective corresponding second MoE layer model parameters in each devices comprises:
according to the respective expert numbers of the tokens, with the goal of equaling numbers of the tokens processed by each device during the expert parallelism computation and preferentially arranging the tokens with the smallest expert numbers in a global range in each device locally, performing load balancing processing based on a greedy algorithm on the tokens in the devices; and
respectively routing the tokens subjected to the load balancing processing to the devices where the respective expert numbers are located currently in an AlltoAll communication mode, so as to cause each device to respectively perform the expert parallelism computation on the respective received tokens according to the respective corresponding second MoE layer model parameters.

7. The staged mixed parallelism reasoning method for an MoE sparse large model according to claim 6, wherein the according to the respective expert numbers of the tokens, with the goal of equaling numbers of the tokens processed by each device during the expert parallelism computation and preferentially arranging the tokens with the smallest expert numbers in a global range in each device locally, performing load balancing processing based on a greedy algorithm on the tokens in the devices comprises:
controlling each device to sort the local tokens in an ascending order of their expert numbers to determine distribution of the respective local tokens of each device among experts, and respectively acquiring distribution of the local tokens of other devices among experts in an AllGather communication mode, so as to determine global distribution of the tokens among experts;
controlling each device to respectively determine token distribution after the device route the tokens to the devices where the respective expert numbers are located currently according to the global distribution of the tokens among experts;
controlling each device to respectively determine initial addresses and offsets of the tokens sent by the device and initial addresses and offsets of the tokens received by the device according to the distribution of the respective local tokens in the experts and the token distribution after the device route the tokens to the devices where the respective expert numbers are located currently; and
inputting the initial addresses and the offsets of the tokens sent by the devices, the initial addresses and the offsets of the tokens received by the devices, a buffer region of sent data and a buffer region of received data as input parameters into an AlltoAll communication function corresponding to the AlltoAll communication mode.

8. The staged mixed parallelism reasoning method for an MoE sparse large model according to claim 7, after determining initial addresses and offsets of the tokens sent by the device and initial addresses and offsets of the tokens received by the device, further comprising:
if it is determined that a device where an expert is missed exists after the AlltoAll communication according to the offsets of the tokens sent by the device and the offsets received by the device, loading the second MoE layer model parameters corresponding to the missed expert from a memory of a processor to the device before the device performs the expert parallelism computation on the tokens based on the second MoE layer model parameters corresponding to the missed expert.

9. A staged mixed parallelism reasoning system for an MoE sparse large model, comprising: a scheduling apparatus and devices in communication connection with the scheduling apparatus;
the scheduling apparatus comprising: a memory, a processor and a computer program stored in the memory and operable on the processor, wherein when the processor executes the computer program, the system implementing a staged mixed parallelism reasoning method for an MoE sparse large model having the steps of:
in a prefill stage of data reasoning based on the MoE sparse large model, controlling architecture layers of the MoE sparse large model to execute a first step layer by layer; wherein the first step comprises: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device ; and then restoring the tokens subjected to the expert parallelism computation to the respective device initial positions and releasing the second MoE layer model parameters in each device; wherein the first MoE layer model parameters run based on a tensor parallelism strategy, and the second MoE layer model parameters run based on an expert parallelism strategy; and
sending a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.

10. The staged mixed parallelism reasoning system for an MoE sparse large model according to claim 9, further comprising:
in each iteration in the decoding stage of data reasoning based on the MoE sparse large model, controlling the architecture layers of the MoE sparse large model to execute a second step layer by layer, and sending a predicted token output by the last architecture layer of the MoE sparse large model in each iteration to the multi-head attention layer in the first architecture layer of the MoE sparse large model in an AlltoAll communication mode;
wherein the second step comprises:
in the current iteration, acquiring respective expert numbers of tokens which correspond to a latest data sequence and are currently respectively located at the respective device initial positions based on the multi-head attention layer model parameters and the gating function in each device; wherein if the current iteration is the first iteration, the latest data sequence comprises the prompt data sequence cached in the prefill stage and the predicted token output by the last architecture layer of the MoE sparse large model in the prefill stage; if the current iteration is not the first iteration, the latest data sequence comprises the prompt data sequence, the predicted token output in the prefill stage and the predicted tokens output in the historical iterations before the current iteration respectively;
collecting the tokens into respective devices in an AllGather communication mode, and causing the respective devices to perform tensor parallelism computation on the gathered tokens according to the respective corresponding first MoE layer model parameters running based on the tensor parallelism strategy according to the respective expert numbers of the tokens; and
restoring the tokens subjected to the tensor parallelism computation to the respective device initial positions in a ReduceScatter communication mode.

11. The staged mixed parallelism reasoning system for an MoE sparse large model according to claim 10, wherein the acquiring respective expert numbers of tokens which correspond to a prompt data sequence and are currently respectively located at respective device initial positions based on multi-head attention layer model parameters and a gating function in each device comprises:
dividing the prompt data sequence into a plurality of first data subsequences according to a total number of the devices; and
inputting each of the first data subsequences into each device on an one to one basis, so as to cause each device to perform multi-head attention computation on the respective received first data subsequences based on the respective stored multi-head attention layer model parameters respectively to obtain tokens corresponding to the respective received first data subsequences, and respectively determining the respective expert numbers of the tokens on each device based on the gating function;
the acquiring respective expert numbers of tokens which correspond to a latest data sequence and are currently respectively located at the respective device initial positions based on the multi-head attention layer model parameters and the gating function in each device comprises:
equally dividing the latest data sequence into a plurality of second data subsequences according to the total number of the devices; and
inputting each of the second data subsequences into each device on an one to one basis, so as to cause each device to perform multi-head attention computation on the respective received second data subsequences based on the respective stored multi-head attention layer model parameters respectively to obtain tokens corresponding to the respective received second data subsequences, and gathering all the tokens onto each device in an AllGather communication mode, so as to cause each device to determine the respective expert numbers of the tokens on each device based on the gating function.

12. The staged mixed parallelism reasoning system for an MoE sparse large model according to claim 9, wherein the meanwhile adding first MoE layer model parameters to each device comprises:
if the time required for adding the first MoE layer model parameters to each device is shorter than or equal to the time required for acquiring the respective expert numbers of the tokens which correspond to the prompt data sequence and are currently respectively located at the respective device initial positions, adding the first MoE layer model parameters to each device while acquiring the respective expert numbers of the tokens which correspond to the prompt data sequence and are currently respectively located at the respective device initial positions.

13. The staged mixed parallelism reasoning system for an MoE sparse large model according to claim 9, before the restoring the tokens subjected to the expert parallelism computation to the respective device initial positions in the first step, further comprising:
if the time required for adding the first MoE layer model parameters to each device is longer than the time required for acquiring the respective expert numbers of the tokens which correspond to the prompt data sequence and are currently respectively located at the respective device initial positions, dividing the respective corresponding first MoE layer model parameters of each device into a first part of parameters and a second part of parameters;
acquiring the respective expert numbers of the tokens which correspond to the prompt data sequence and are currently respectively located at the respective device initial positions based on the multi-head attention layer model parameters and the gating function in each device, and meanwhile adding the first part of parameters to each device; and
then performing the expert parallelism computation on the tokens according to the respective expert numbers of the tokens and the respective corresponding second MoE layer model parameters in each device, and meanwhile adding the second part of parameters to each device.

14. The staged mixed parallelism reasoning system for an MoE sparse large model according to claim 9, wherein the performing the expert parallelism computation on the tokens according to the respective expert numbers of the tokens and the respective corresponding second MoE layer model parameters in each devices comprises:
according to the respective expert numbers of the tokens, with the goal of equaling numbers of the tokens processed by each device during the expert parallelism computation and preferentially arranging the tokens with the smallest expert numbers in a global range in each device locally, performing load balancing processing based on a greedy algorithm on the tokens in the devices; and
respectively routing the tokens subjected to the load balancing processing to the devices where the respective expert numbers are located currently in an AlltoAll communication mode, so as to cause each device to respectively perform the expert parallelism computation on the respective received tokens according to the respective corresponding second MoE layer model parameters.

15. The staged mixed parallelism reasoning system for an MoE sparse large model according to claim 14, wherein the according to the respective expert numbers of the tokens, with the goal of equaling numbers of the tokens processed by each device during the expert parallelism computation and preferentially arranging the tokens with the smallest expert numbers in a global range in each device locally, performing load balancing processing based on a greedy algorithm on the tokens in the devices comprises:
controlling each device to sort the local tokens in an ascending order of their expert numbers to determine distribution of the respective local tokens of each device among experts, and respectively acquiring distribution of the local tokens of other devices among the experts in an AllGather communication mode, so as to determine global distribution of the tokens among the experts;
controlling each device to respectively determine token distribution after the device route the tokens to the devices where the respective expert numbers are located currently according to the global distribution of the tokens among the experts;
controlling each device to respectively determine initial addresses and offsets of the tokens sent by the device and initial addresses and offsets of the tokens received by the device according to the distribution of the respective local tokens in the experts and the token distribution after the device route the tokens to the devices where the respective expert numbers are located currently; and
inputting the initial addresses and the offsets of the tokens sent by the devices, the initial addresses and the offsets of the tokens received by the devices, a buffer region of sent data and a buffer region of received data as input parameters into an AlltoAll communication function corresponding to the AlltoAll communication mode.

16. The staged mixed parallelism reasoning system for an MoE sparse large model according to claim 15, after determining initial addresses and offsets of the tokens sent by the device and initial addresses and offsets of the tokens received by the device, further comprising:
if it is determined that a device where an expert is missed exists after the AlltoAll communication according to the offsets of the tokens sent by the device and the offsets received by the device, loading the second MoE layer model parameters corresponding to the missed expert from a memory of a processor to the device before the device performs the expert parallelism computation on the tokens based on the second MoE layer model parameters corresponding to the missed expert.

17. A computer program product, comprising a computer program, the computer program, when executed by a processor, implementing a staged mixed parallelism reasoning method for an MoE sparse large model comprising the steps of:
in a prefill stage of data reasoning based on the MoE sparse large model, controlling architecture layers of the MoE sparse large model to execute a first step layer by layer; wherein the first step comprises: acquiring respective expert numbers of tokens which correspond to a prompt data sequence and are currently respectively located at respective device initial positions based on multi-head attention layer model parameters and a gating function in each device, and meanwhile adding first MoE layer model parameters to each device; then performing expert parallelism computation on the tokens according to the respective expert numbers of the tokens and respective corresponding second MoE layer model parameters in each device ; and then restoring the tokens subjected to the expert parallelism computation to the respective device initial positions and releasing the second MoE layer model parameters in each device; wherein the first MoE layer model parameters run based on a tensor parallelism strategy, and the second MoE layer model parameters run based on an expert parallelism strategy; and
sending a predicted token output by the last architecture layer of the MoE sparse large model to a multi-head attention layer in the first architecture layer of the MoE sparse large model, so as to execute a decoding stage of data reasoning of the MoE sparse large model according to the predicted token, the multi-head attention layer model parameters and the gating function in each device, and the first MoE layer model parameters in each device.
